(19) United States
(12) Patent Application Publication
(10) Pub. No.: US 2019/0059119 A1
(43) Pub. Date: Feb. 21, 2019

(54) USER EQUIPMENT, BASE STATION, CONNECTION ESTABLISHMENT METHOD, AND CONTEXT INFORMATION RETRIEVAL METHOD

(71) Applicant: NTT DOCOMO, INC., Tokyo (JP)

(72) Inventors: Wuri Andarmawanti Hapsari, Tokyo (JP); Hideaki Takahashi, Tokyo (JP)

(73) Assignee: NTT DOCOMO, INC., Tokyo (JP)

(21) Appl. No.: 15/770,891

(22) PCT Filed: Nov. 4, 2016
(86) PCT No.: PCT/JP2016/082816

§ 371 Date: Apr. 25, 2018

(30) Foreign Application Priority Data
Nov. 5, 2015 (JP) 2015-218016
Feb. 4, 2016 (JP) 2016-020322

(51) Int. Cl. H04W 76/10

(52) U.S. Cl. CPC H04W 76/10

(57) ABSTRACT

User equipment of a mobile communication system supporting a function for establishing a connection by reusing context information retained in each of the user equipment and a base station includes a transmitter that transmits, to the base station, first identifying information for identifying a retaining base station that retains base station side context information for the user equipment and second identifying information for identifying the base station side context information when the user equipment retains user equipment side context information; and a connector that establishes the connection with the base station by using the user equipment side context information after the base station obtains the base station side context information from the retaining base station.

### TECHNICAL FIELD

The present invention relates to a technique for user equipment UE and a base station eNB of a mobile communication system to retain UE context.

### BACKGROUND ART

In a LTE system, a connection state of user equipment UE (which is described as UE, hereinafter) with a base station eNB (which is described as eNB, hereinafter) is represented by two states, which are a RRC (Radio Resource Control) idle state (RRC_Idle) and a RRC connected state (RRC_Connected).

When the UE connects to a network, UE context is generated by a MME (Mobility Management Entity) at the side of a core NW; and, during the RRC connected state, the UE context is retained by both the eNB to which the UE is connected and the UE. Note that the UE context is information including bearer related information, security related information, and so forth.

When the UE transitions between the RRC idle state and the RRC connected state, a large amount of signaling for call control occurs, which includes that of a core NW side, so that a problem is how to reduce the signaling.

For example, upon causing the UE to transition from the RRC connected state to the RRC idle state, signaling, such as that shown in FIG. 1, occurs (Non-Patent Document 1, etc.). The case of FIG. 1 is such that, upon detecting that communication of the UE 1 does not occur for a predetermined time period, the eNB 2 causes UE 1 to transition to the RRC idle state by disconnecting the connection with the UE 1.

In FIG. 1, the eNB 2 transmits a UE context release request (UE Context Release Request) to the MME 3 (step 1). The MME 3 transmits a bearer release request (Release Access Bearers Request) to an S-GW 4 (step 2); and the S-GW-4 returns a bearer release response (Release Access Bearers Response) to the MME 3 (step 3).

The MME 3 transmits a UE context release command (UE Context Release Command) to the eNB 2 (step 4). The eNB 2 transmits a RRC connection release (RRC Connection Release) to the UE 1 (step 5), so that the UE 1 is caused to release the UE context to transition to the RRC idle state. Furthermore, the eNB 2 releases the UE context; and transmits a UE context release complete (UE Context Release Complete) to the MME 3 (step 6).

### PRIOR ART DOCUMENT

### Non-Patent Document

Non-Patent Document 1: 3GPP TS 36.413 V12.4.0 (2014-12)
Non-Patent Document 2: 3GPP TSG RAN Meeting #66 RP-142030 Maui, USA, 8-11 Dec. 2014
Non-Patent Document 3: 3GPP TR 23.720 V1.1.0 (2015-10)
Non-Patent Document 4: 3GPP TS 36.331 V12.6.0 (2015-06)
Non-Patent Document 5: 3GPP TS 36.300 V13.1.0 (2015-09)

### SUMMARY OF INVENTION

### Problem to be Solved by the Invention

In the signaling procedure shown in FIG. 1, a large amount of signaling occurs not only at the time of releasing the RRC connection, but also a large amount of signaling occurs for configuring the UE context when the UE transitions from the RRC idle state to the RRC connected state again.

In order to reduce signaling for the UE to transition between the RRC idle state and the RRC connected state, a study of a method has been started such that, when the state of the UE transitions within the same eNB as follows: the RRC connected state→the RRC idle state→the RRC connected state, the UE context is kept retained by the eNB and the UE so as to reuse it (Non-Patent Document 2). An example of the procedure that can be considered in the method is described by referring to FIG. 2.

The state illustrated in (a) of FIG. 2 is a state such that the UE 1 is in the RRC connected state, and the connection of S1-C and the connection of the S1-U (S1-C/U in the figure) related to the UE 1 have been established at the core NW side. Note that the S1-C connection is an S1 connection for transmitting a C-plane signal; and the S1-U connection is an S1 connection that passes through a U-plane.

As illustrated in (b) and (c), by the RRC connection release (RRC Connection Release), the UE 1 is caused to transition from the state illustrated in (a) to the RRC idle state. At this time, the UE context for the UE 1 in the eNB 2 is kept retained; the UE context for the eNB 2 in the UE 1 is kept retained; and the S1-C/U connection to the UE 1 is also maintained. Then, as illustrated in (d), when the UE 1 transitions to the RRC connected state, the eNB 2 and the UE 1 establish the RRC connection while reducing the signaling by reusing the retained UE context.

Here, the case illustrated in (d) of FIG. 2 shows an example where the UE 1 is kept belonging to the cell of the eNB 2, and the RRC connection is established using, by each of the UE 1 and the eNB 2, the retained UE context.

Here, for example, as illustrated in FIG. 3, suppose that the UE 1 transitions from the RRC connection state to the RRC idle state in the cell under control of the eNB A; and that the UE 1 moves to a cell under control of a different eNB B while maintaining the RRC idle state (while retaining the UE context). In this case, even if the UE 1 attempts to establish a connection with the eNB B while reusing the retained UE context, the eNB B does not retain the UE context for establishing a connection with the UE 1, so that a connection reusing the UE context may not be established. It follows that the connection is to be established by a procedure that is the same as the usual one, and the problem is that the signaling number may not be reduced.

The present invention has been achieved in view of the above-described point, and an object is to provide a technique for allowing, even if user equipment that is not in a connected state moves between cells, the user equipment to establish a connection with a base station by reusing context information, in a mobile communication system supporting a function for establishing a connection by reusing context information retained in each of the user equipment and the base station.

### Means for Solving the Problem

According to an embodiment of the present invention, there is provided user equipment of a mobile communication system supporting a function for establishing a connection by reusing context information retained in each of the user equipment and a base station, the user equipment including a transmitter that transmits, to the base station, first identifying information for identifying a retaining base station that retains base station side context information for the user equipment and second identifying information for identifying the base station side context information when the user equipment retains user equipment side context information; and a connector that establishes the connection with the base station by using the user equipment side context information after the base station obtains the base station side context information from the retaining base station.

Furthermore, according to an embodiment of the present invention, there is provided a base station of a mobile communication system supporting a function for establishing a connection by reusing context information retained in each of user equipment and the base station, the base station including a receiver that receives first identifying information for identifying a retaining base station that retains base station side context information for the user equipment and second identifying information for identifying the base station side context information from the user equipment that retains user equipment side context information; and a context retriever that transmits, to the retaining base station identified by the first identifying information, a context request message including the second identifying information, and that obtains the base station side context information that is transmitted from the retaining base station in response to the context request message.

Furthermore, according to an embodiment of the present invention, there is provided a connection establishment method to be executed by user equipment of a mobile communication system supporting a function for establishing a connection by reusing context information retained in each of the user equipment and a base station, the connection establishment method including a transmission step of transmitting, to the base station, first identifying information for identifying a retaining base station that retains base station side context information for the user equipment and second identifying information for identifying the base station side context information when the user equipment retains user equipment side context information; and a connection step of establishing the connection with the base station by using the user equipment side context information after the base station obtains the base station side context information from the retaining base station.

Furthermore, according to an embodiment of the present invention, there is provided a content information retrieval method to be executed by a base station of a mobile communication system supporting a function for establishing a connection by reusing context information retained by each of user equipment and the base station, the content information retrieval method including a reception step of receiving, from the user equipment that retains user equipment side context information, first identifying information for identifying a retaining base station that retains base station side context information for the user equipment and second identifying information for identifying the base station side context information; and a context retrieval step of transmitting, to the retaining base station identified by the first identifying information, a context request message including the second identifying information, and obtaining the base station side context information that is transmitted from the retaining base station in response to the context request message.

### Advantage of the Invention

According to embodiments of the present invention, there is provided a technique for allowing, even if user equipment that is not in a connected state moves between cells, the user equipment to establish a connection with a base station by reusing context information, in a mobile communication system supporting a function for establishing a connection by reusing context information retained in each of the user equipment and the base station.

### BRIEF DESCRIPTION OF DRAWINGS

FIG. 1 is a diagram illustrating an example of a signaling sequence for transition to a RRC idle state;

FIG. 2 is a diagram for illustrating an example of a process when UE context is retained;

FIG. 3 is a diagram for illustrating a problem;

FIG. 4 is a configuration diagram of a communication system according to an embodiment of the present invention;

FIG. 5 is a diagram illustrating an example of a processing sequence by an entire system of an embodiment 1;

FIG. 6 is a diagram illustrating an example of the processing sequence by the entire system of the embodiment 1;

FIG. 7 is a diagram illustrating an example 1 of a method of reporting identifying information of an eNB in the embodiment 1;

FIG. 8 is a diagram illustrating an example 2 of the method of reporting the identifying information of the eNB in the embodiment 1;

FIG. 9 is a diagram illustrating an example 1 of a context retrieval procedure in the embodiment 1;

FIG. 10 is a diagram illustrating an example 2 of the context retrieval procedure in the embodiment 1;

FIG. 11 is a diagram illustrating an example of a processing sequence by an entire system of an embodiment 2;

FIG. 12 is a diagram illustrating a connection establishment procedure in the embodiment 2;

FIG. 13 is a diagram illustrating a connection release procedure in the embodiment 2;

FIG. 14 is a diagram illustrating another example of the processing sequence by the entire system of the embodiment 2;

FIG. 15A is a diagram illustrating an example of changing a specification of a RRCConnectionRequest message;

FIG. 15B is a diagram illustrating the example of changing the specification of a RRCConnectionRequest message;

FIG. 16A is a diagram illustrating an example of changing a specification of a RRCConnectionSetup message;

FIG. 16B is a diagram illustrating the example of changing the specification of the RRCConnectionSetup message;

FIG. 17 is a diagram illustrating an example of changing a specification of a RRCConnectionSetupComplete message;

FIG. 18A is a diagram illustrating an example 1 of changing a specification of a RRCConnectionRelease message;

FIG. 18B is a diagram illustrating the example 1 of changing the specification of the RRCConnectionRelease message;

FIG. 19A is a diagram illustrating an example 2 of changing the specification of the RRCConnectionRelease message;

FIG. 19B is a diagram illustrating the example 2 of changing the specification of the RRCConnectionRelease message;

FIG. 20 is a diagram illustrating an example of a method of reporting identifying information of an eNB in the embodiment 2;

FIG. 21 is a diagram illustrating an example 1 of a context retrieval procedure in the embodiment 2;

FIG. 22 is a diagram illustrating an example 2 of the context retrieval procedure in the embodiment 2;

FIG. 23 is a diagram illustrating a modified example 1 of the method of reporting the identifying information of the eNB in the embodiment 2;

FIG. 24 is a diagram illustrating an example of changing a specification in a modified example 1;

FIG. 25 is a diagram illustrating a modified example 2 of the method of reporting the identifying information of the eNB in the embodiment 2;

FIG. 26 is a diagram illustrating an example of changing a specification in the modified example 2;

FIG. 27 is a configuration diagram of a MME and a S-GW;

FIG. 28 is a configuration diagram of a UE 50;

FIG. 29 is a HW configuration diagram of the UE 50;

FIG. 30 is a configuration diagram of an eNB 10; and

FIG. 31 is a HW configuration diagram of the eNB 10.

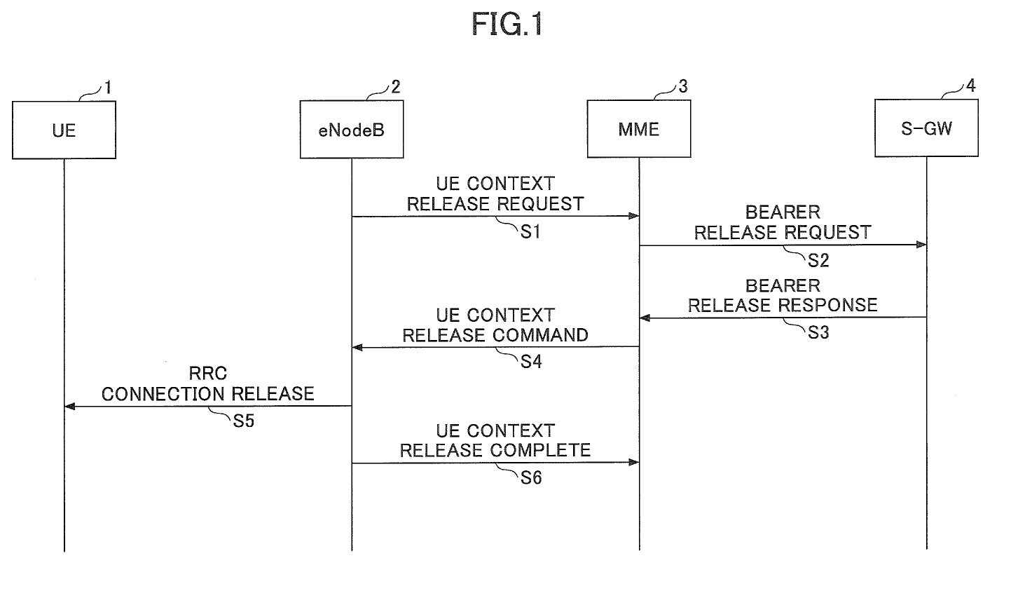

### EMBODIMENTS OF THE INVENTION

Embodiments of the present invention are described below by referring to the figures. Note that the embodiments described below are merely examples; and embodiments to which the present invention is applied are not limited to the embodiments below. For example, the embodiments are directed to a LTE system; however, the present invention can be applied without limiting to LTE. Furthermore, in the specification and the claims, the term “LTE” is not limited to a specific Rel (release) of 3GPP, unless otherwise specified.

(Overall System Configuration)

FIG. 4 is a diagram illustrating an example of a configuration of a communication system in the embodiment of the present invention. As illustrated in FIG. 4, the communication system according to the embodiment includes an eNB 10; an eNB 20; a MME 30; a S-GW (Serving Gateway) 40; and a UE 50. Note that FIG. 4 only shows a part of a core network (EPC) that is related to the embodiment.

The UE 50 is user equipment such as a mobile phone. Each of the eNBs 10 and 20 is a base station. The MME 30 is a node device that accommodates an eNB; and that performs mobility control, such as location registration, paging, and handover, bearer establishment/deletion, and so forth. The S-GW 40 is a node device that relays user data (U-Plane data). Note that the system formed of the MME 30 and the S-GW 40 is referred to as a communication control device. Alternatively, the MME 30 and the S-GW 40 may be configured as a single device, which may be referred to as a communication device.

As illustrated in FIG. 4, the MME 30 and the eNBs 10 and 20 are connected via an S1-MME interface; and the S-GW 40 and the eNBs 10 and 20 are connected via an S1-U interface. Furthermore, the eNBs are connected via an X2 interface.

In the embodiment, a method is assumed such that, even if the UE 50 transitions from a RRC connected state to a non-RRC connected state, UE context of the UE 50 is retained. As described above, this method allows a number times of signaling to be reduced.

In the embodiment, an embodiment based on a method described in Non-Patent Document 3, as an example of the above-described method, that defines a new RRC state, which is RRC-Suspended (and ECM-Suspended), is described as an embodiment 1; and an embodiment based on a method that reuses the UE context without defining a new RRC state is described as an embodiment 2.

### Embodiment 1

First, the embodiment 1 is described. As described above, in the method of the embodiment 1, in addition to the existing RRC-Idle (RRC idle state) and RRC-Connected (RRC connected state), a state called RRC-Suspended (which is referred to as RRC suspended state) is added. In the RRC suspended state, each of the UE and the eNB retains the UE context that is used for a connection in the RRC state prior to entering the RRC suspended state. Then, upon transitioning from the RRC suspended state to the RRC connected state, the RRC connection is established using the retained UE context.

In the embodiment 1 of the embodiment, even if the UE 50 transitions from the RRC connected state to the RRC suspended state in a cell under control of a certain eNB and the UE moves to a cell under control of another eNB while maintaining that state, the UE 50 can reuse the UE context in the cell under control of the eNB after the movement so as to establish a RRC connection (transition to the RRC connected state).

### Embodiment 1: Example of Overall Sequence

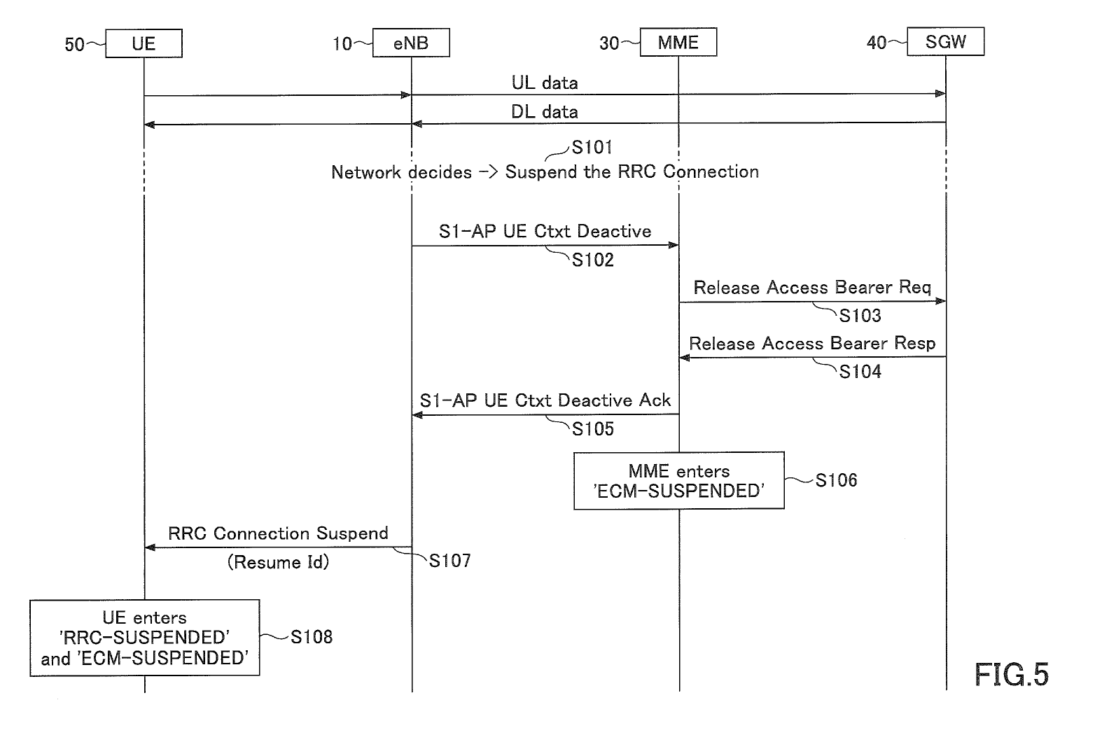

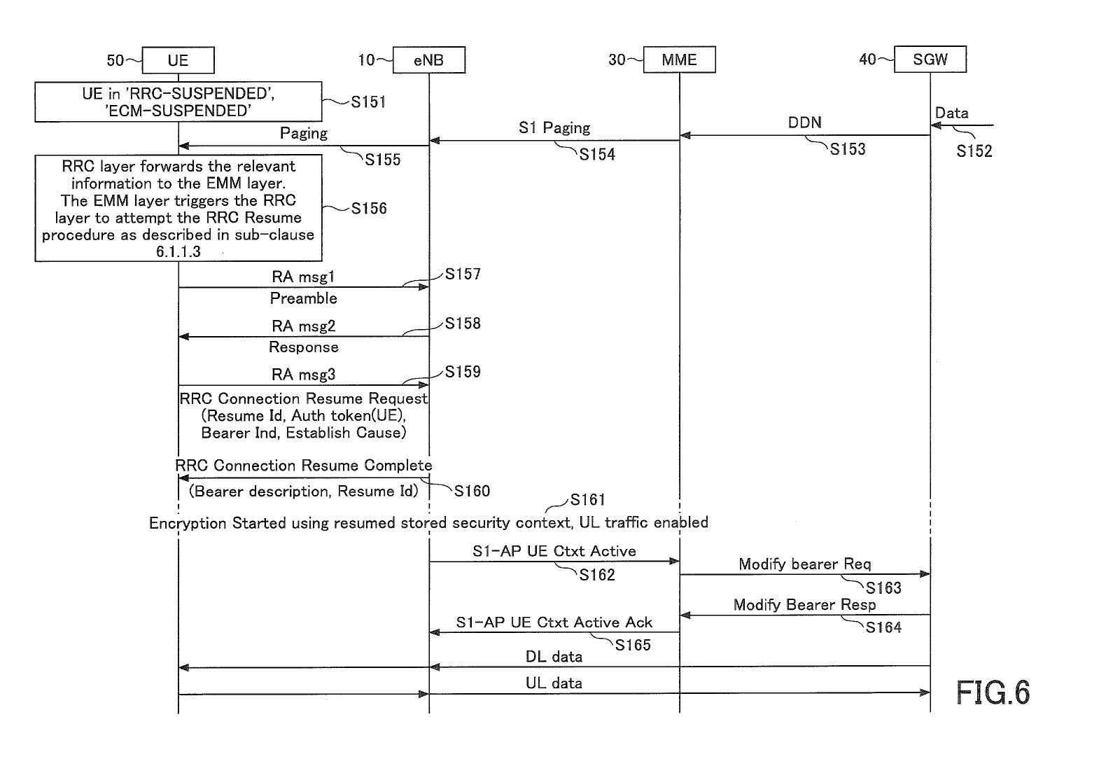

First, as an example of a sequence of the entire communication system in the embodiment 1, a processing sequence is described by referring to FIG. 5 in which the UE 50 transitions from the RRC idle state to the RRC suspended state (and an ECM suspended state). Note that the entire processing sequence itself is illustrated in FIG. 5 and FIG. 6 is disclosed in Non-Patent Document 3.

At step 101, the eNB 10 determines to suspend the RRC connection. At step 102, the eNB 10 transmits, to the MME 30, a message indicating that the RRC connection of the UE 50 is suspended. The MME 30 and the eNB 10 retain UE contexts, respectively.

After the message transmission and reception at steps 103 and 104, the MME 30 returns, at step 105, an Ack with respect to step 102. At step 106, the MME 30 enters the ECM-SUSPENDED state.

At step 107, the eNB 10 transmits a RRC connection suspended message to the UE 50 so as to cause UE 50 to be in the RRC suspended state (step 108). The RRC connection suspend message includes a Resume ID (resume ID). The Resume ID is an identifier to be used for restarting the RRC connection for the next time. In the RRC suspended state, each of the UE 50 and the eNB 10 stores the UE context.

Here, in the embodiment 1, the UE context that can be retained in each of the UE 50 and the eNB 10 is, for example, the RRC configuration (RRC configuration), the bearer configuration (bearer configuration: including RoHC state information, etc.), the AS security context (Access Stratum Security Context), the L2/L1 parameter (e.g., configurations of MAC and PHY), etc.

Furthermore, the UE 50 and the eNB 10 may retain the same information as the UE context; or UE 50 may only retain information of the UE context required for a connection to the eNB 10, and the eNB 10 may only retain information of the UE context required for the connection to the UE 50.

More specifically, for example, each of the UE 50 and the eNB 10 may retain, as the UE context, the information of RadioResourceConfigDedicated transmitted in the RRC Connection Setup; the capability information transmitted in the RRC Connection Setup Complete; security related information (e.g., key information), the security related information transmitted in the RRC Security Mode Command; configuration information transmitted in the RRC Connection Reconfiguration, etc. Note that these are merely examples, and the information retained as the UE context is not limited to these; and information may be retained additionally, or a part of these information items may not be retained.

By retaining the above-described information items as the UE context, each of the UE 50 and the eNB 10 can establish, upon transitioning from the RRC suspended state to the RRC connected state, the RRC connection without transmitting and receiving a message, such as RRC Connection Setup Complete, RRC Security Mode Command, RRC Security Mode Complete, RRC Connection Reconfiguration, RRC Connection Reconfiguration Complete, etc.

Next, an example of a sequence for the UE 50 to transition from the RRC suspended state to the RRC connected state is described by referring to FIG. 6. FIG. 6 shows a case where the UE 50 in the RRC suspended state (step S151) receives a terminating call (step 152 through 155); however, this is an example, and the similar process is performed as long as reusing of the UE context is concerned when the UE 50 in the RRC suspended state makes an originating call.

In the UE that receives paging from the eNB 10, at step 156, the RRC resume procedure (resume procedure) is activated from the EMM layer. At step 157, a Random Access Preamble is transmitted from the UE 50 to the eNB 10; and, at step 158, a Random Access Response is returned from the eNB 10 to the UE 50.

At step 159, the UE 50 transmits, to the eNB 10, the RRC Connection Resume Request message as the message 3.

The RRC Connection Resume Request message includes a Resume Id (resume ID) that is information indicating that the UE 50 retains the UE context. Upon receiving the RRC Connection Resume Request message, the eNB 10 retrieves the UE context of the UE 50 that is stored while being associated with the Resume Id included in the message, and resumes the bearer, etc., based on the information of the UE context. Note that, when the UE context of the UE 50 is not stored, the context retrieval process is to be executed, which is described below.

At step 160, the eNB 10 transmits, to the UE 50, the RRC Connection Resume Complete message including the Resume Id.

At step 161, the UE 50 and the eNB 10 resume the stored security context. Then, in step 162 to step 165, reporting, etc., of the state update of the UE 50 to the MME 30 is performed.

### Embodiment 1: An Example of a Procedure Between the UE 50 and the eNB 20

In the above-described examples illustrated in FIG. 5 and FIG. 6, the UE 50 transitions from the RRC connected state to the RRC suspended state under the control of the same eNB 10; and then transitions to the RRC connected state again.

In the following, a case is described such that UE 50 transitions from the RRC connected state to the RRC suspended state under the control of the eNB 10 (the process of FIG. 5); and then the UE 50 moves to a cell under control of the eNB 20, which is different from the eNB 10. Note that, each of the eNB 10 and the eNB 20 is provided with a context retaining function, such as those described in FIG. 5 and FIG. 6; and is provided with a function for executing a context retrieval procedure, as described below.

### Example 1

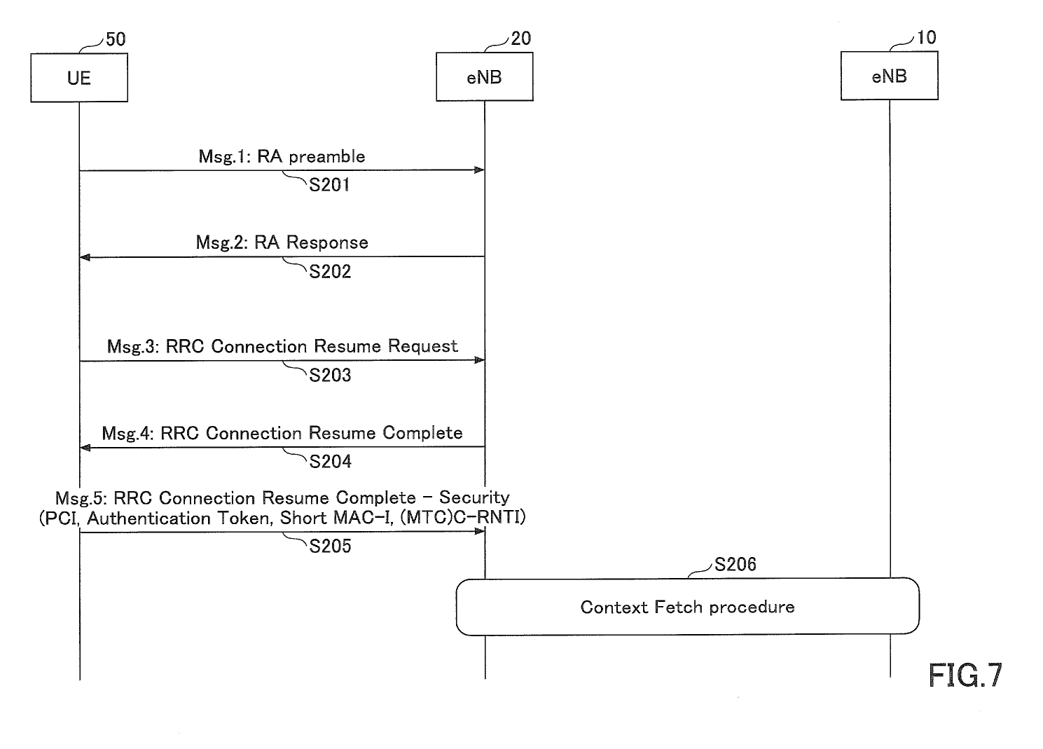

First, an example 1 of a processing procedure between the UE 50 and the eNB 20 is described by referring to FIG. 7. As an assumption of the process of FIG. 7, the UE 50 is in the RRC suspended state and retains the UE context at the time of connecting to the eNB 10 together with the Resume Id. Then, a situation is assumed such that the UE 50 moves to a cell under control of the eNB 20 while keeping the RRC suspended state; and triggered by originating a call, or triggered by receiving an incoming call, the RRC resume procedure (resume procedure) is activated.

At step 201, a Random Access Preamble is transmitted from the UE 50 to the eNB 20; and, at step 202, a Random Access Response is returned from the eNB 20 to the UE 50.

At step 203, the UE 50 transmits a RRC Connection Resume Request message to the eNB 20.

The RRC Connection Resume Request message includes the Resume Id (resume ID) that is obtained by the UE 50 from the eNB 10. The eNB 20 that receives the RRC Connection Resume Request message searches for the UE context of the UE 50 that is stored while being associated with the Resume Id included in the message; however, the eNB 20 may not detect the UE context of the UE 50. Alternatively, since there is no Resume ID that matches the received Resume Id, it is determined that the UE context of the UE 50 does not exist. Consequently, at step 204, the eNB 20 transmits, to the UE 50, a RRC Connection Resume Complete message including information that indicates that the UE context of the UE 50 does not exist in the eNB 20. Note that the message at step 204 is not limited to the RRC Connection Resume Complete message, and it may be another message.

Upon receiving a message including the above-described message, the UE 50 transmits, at step 205, a RRC Connection Resume Complete-Security message to the eNB 20 so as to cause the eNB 20 to execute the context retrieval procedure (Context Fetch procedure). Note that the message transmitted at step 205 is not limited to the RRC Connection Resume Complete-Security message, and it can be another message.

The message to be transmitted at step 205 includes information for identifying an eNB (which is the eNB 10 here) that retains the eNB side UE context corresponding to the UE context retained by the UE 50; and information for identifying (and authenticating) that the UE context is for the UE 50 (information for identifying the UE context of the UE 50).

In the example of FIG. 7, PCI (a physical cell ID for identifying the eNB 10) is included as the information for identifying the eNB (the eNB 10 here) that retains the eNB side UE context. Note that the information for identifying the eNB is not limited to the PCI, and it can be any other information, such as the eNB ID.

Furthermore, Authentication Token, Short MAC-I, and (MTC)C-RNTI are included as the information for identifying the UE context of the UE 50. Note that the information for identifying the UE context of the UE 50 may not be all of the above-described information items; and it can be a part of these. Furthermore, information items other than these may be used. In general, as the information for identifying the UE context of the UE 50, information that corresponds to the UE 50 and that is included in the UE context retained by the eNB 10 or the information retained by the eNB 10 while being associated with the UE context (the information associated with the UE 50) can be used. These information items may be information that is calculated by a security related algorithm, which has been known to the UE 50 and the eNB 10, based on the ID, etc., of the UE 50.

Note that, since the method of the embodiment 1 relates to the MTC (Machine Type Communication), it is indicated that the (MTC)C-RNTI (an AS layer ID corresponding to the RNTI for identifying the MTC UE) is the identifying information for identifying the UE 50; however, this is an example, and a C-RNTI for a usual UE may be used. The C-RNTI here is the C-RNTI obtained when the UE 50 is connected to the eNB 10.

The Authentication Token transmitted here is a part of the UE context retained by the UE 50; and it is used in the eNB 10 for identifying and authenticating the security context in the UE context of the UE 50. Furthermore, Short MAC-I and C-RNTI are used for identifying and authenticating the UE context of the UE 50 in the eNB 10. Note that each of Authentication Token and Short MAC-I is a bit sequence (which may be a part of a bit sequence) generated at least using a security key of the AS layer of the UE.

The eNB 20 that receives the message at step 205 executes a context retrieval procedure with the eNB 10 identified by the PCI, etc. Details of the context retrieval procedure are described below.

Note that, in the above-described example, the information indicating whether the eNB 20 retains the UE context is reported to the UE 50; however, such reporting may not be performed. In this case, the UE 50 transmits identification information for identifying the UE context (e.g., Authentication Token, Short MAC-I, (MTC)C-RNTI) to the eNB 20, regardless of whether the eNB 20 retains the UE context. Upon detecting that the own device does not retain the UE context corresponding to the identification information, the eNB 20 executes the context retrieval procedure (context fetch procedure) described below.

### Example 2

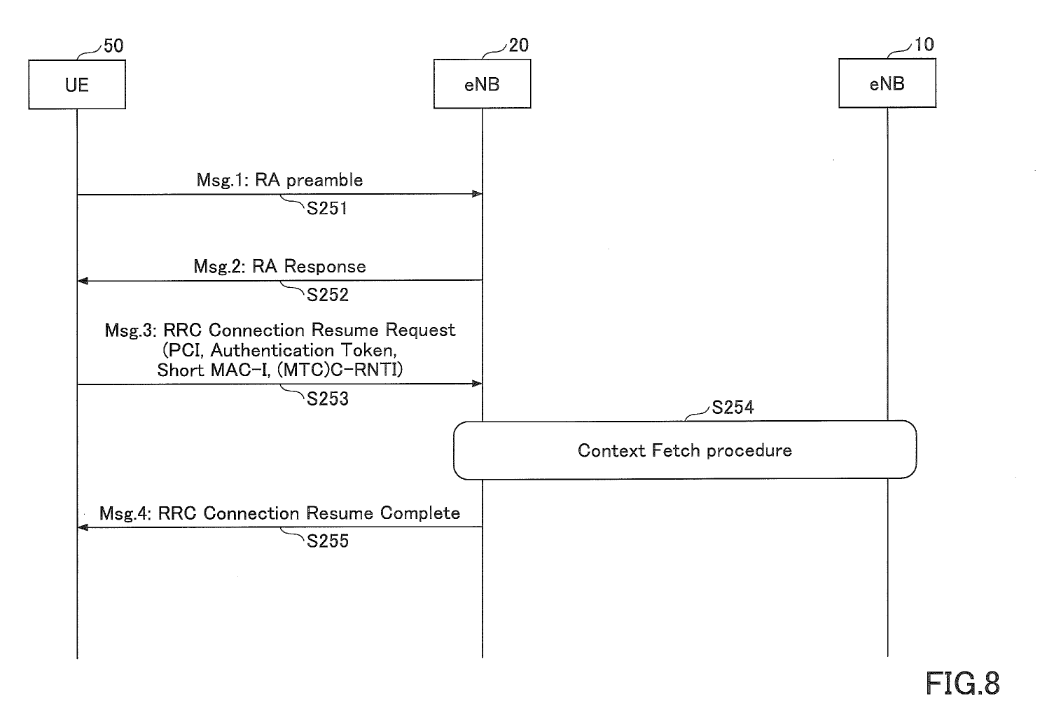

Next, an example 2 of a processing procedure between the UE 50 and the eNB 20 is described by referring to FIG. 8. The assumption is the same as that of FIG. 7.

At step 251, a Random Access Preamble is transmitted from the UE 50 to the eNB 20; and, at step 252, a Random Access Response is returned from the eNB 20 to the UE 50.

At step 253, the UE 50 transmits a RRC Connection Resume Request message to the eNB 20. In the example 2, information for identifying the eNB retaining the UE context (here, the eNB 10) and information for identifying the UE context of the UE 50 are included in the RRC Connection Resume Request message. The contents of these information items are the same as those of the example 1. Namely, in the example 2, the UE 50 transmits the identification information for identifying the UE context to the eNB 20 without confirming whether the eNB 20 retains the UE context.

The RRC Connection Resume Request message includes the Resume Id (resume ID) that is obtained by the UE 50 from the eNB 10. The eNB 20 that receives the RRC Connection Resume Request message searches for the UE context of the UE 50 that is stored while being associated with the Resume Id included in the message; however, the eNB 20 may not detect the UE context of the UE 50. Alternatively, since there is no Resume ID that matches the received Resume Id, it is determined that the UE context of the UE 50 does not exist.

Consequently, the eNB 20 executes the context retrieval procedure using the information for identifying the eNB retaining the UE context (here, the eNB 10) and the information for identifying the UE context of the UE 50, which are included in the RRC Connection Resume Request message (step 254). Note that, if the eNB 20 retains the UE context of the UE 50, the process proceeds to step 255 without executing the context retrieval procedure.

The eNB 20 obtains the UE context of the UE 50 at step 254; and resumes the bearer based on the information of the UE context, for example. Then, at step 255, the eNB 20 transmits a RRC Connection Resume Complete message to the UE 50. In this manner, the RRC connection can be established between UE 50 and the eNB 20 by reusing the UE context.

### Embodiment 1: Example 1 of the Context Retrieval Procedure

Next, an example 1 of the context retrieval procedure and an example 2 of the context retrieval procedure are described, which are the detailed examples of the context retrieval procedures illustrated in FIG. 7 and FIG. 8. The example 1 of the context retrieval procedure is an example of a procedure utilizing a message related to inter-eNB communication using the X2 interface, which is described in Non-Patent Document 5, etc.; and the example 2 of the context retrieval procedure is an example of a procedure using a new message using the X2 interface.

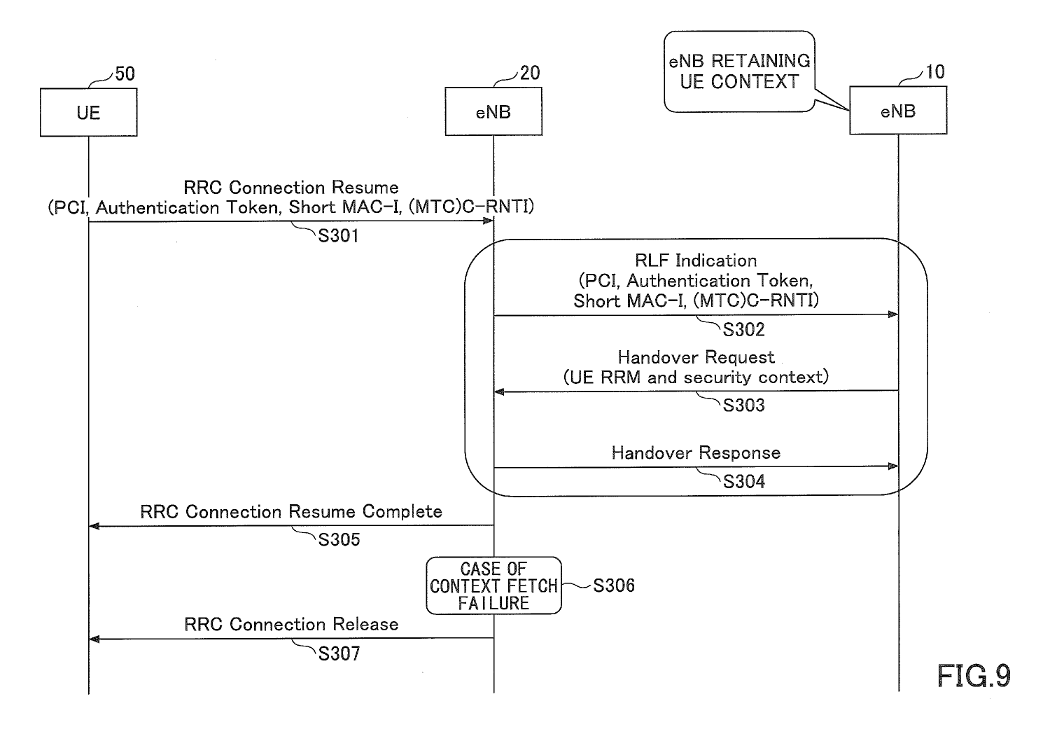

First, the example 1 of the content retrieval procedure is described by referring to FIG. 9. In FIG. 9, the example 2 of the procedure between the UE 50 and the eNB 20 is illustrated; and, for the example 1, the details of the context retrieval procedure are the same.

At step 301, the UE 50 transmits a RRC Connection Resume Request message to the eNB 20. The information for identifying the eNB retaining the UE context of the UE 50 (here, the eNB 10) and the information for identifying the UE context of the UE 50 are included in the RRC Connection Resume Request message. Specifically, as described above, PCI, Authentication Token, Short MAC-I, and (MTC)C-RNTI are included.

At step 302, the eNB 20 transmits a RLF Indication (Radio Link Failure Indication: radio link failure indication) message to the eNB 10 identified by the PCI. The information for identifying the eNB retaining the UE context of the UE 50 received from the UE 50 (here, the eNB 10) and the information for identifying the UE context of the UE 50 are included in the RLF Indication message. Namely, PCI, Authentication Token, Short MAC-I, and (MTC)C-RNTI are included.

At step 302, the eNB 10 that receives the RLF Indication message retrieves the UE context of the UE 50 from a plurality of items of the UE context stored in the storage unit of the eNB 10 based on the information for identifying the UE context of the UE 50.

Then, at step 303, the eNB 10 transmits a Handover Request message including the retrieved UE context to the eNB 20. Note that, in FIG. 9, as an example of the contents of the UE context, the UE RRM and security context (radio resource management and security context of the UE) is shown.

The eNB 20 that receives the Handover Request message returns, at step 304, the Handover Response message to the eNB 10.

The eNB 20 that retrieves the UE context of the UE 50 resumes the bearer, etc.; and transmits, to the UE 50, the RRC Connection Resume Complete message including the Resume Id at step 305. In this manner, the UE 50 and the eNB 20 establish the connection between the UE 50 and the eNB 20 by reusing the UE context; and cause the state to transition to the RRC connected state.

Note that, if the eNB 20 executes the context retrieval procedure and the target UE context is not obtained (step 306), the RRC Connection Release message, for example, is transmitted so as to cause the UE 50 to transition to the RRC idle state. Note that, in this case, the RRC Connection Resume Complete message may be transmitted, or may not be transmitted.

### Embodiment 1: Example 2 of the Context Retrieval Procedure

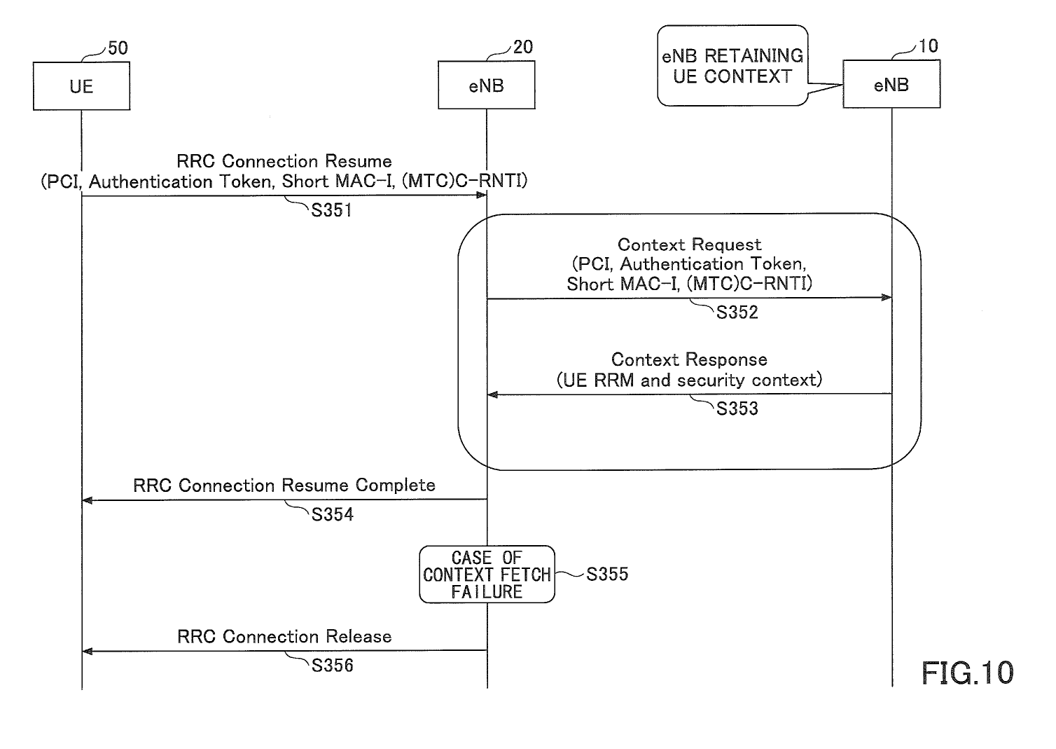

Next, the example 2 of the context retrieval procedure is described by referring to FIG. 10. In FIG. 10, the example 2 of the procedure between the UE 50 and the eNB 20 is illustrated; and, for the example 1, the details of the context retrieval procedure are the same.

At step 351, the UE 50 transmits a RRC Connection Resume Request message to the eNB 20. The information for identifying the eNB retaining the UE context of the UE 50 (here, the eNB 10) and the information for identifying the UE context of the UE 50 are included in the RRC Connection Resume Request message. Specifically, as described above, PCI, Authentication Token, Short MAC-I, and (MTC)C-RNTI are included.

At step 352, the eNB 20 transmits a Context Request message (a context request message) to the eNB 10 identified by the PCI. The information for identifying the eNB retaining the UE context of the UE 50 received from the UE 50 (here, the eNB 10) and the information for identifying the UE context of the UE 50 are included in the Context Request message. Namely, PCI, Authentication Token, Short MAC-I, and (MTC)C-RNTI are included. Note that, since the RLF Indication message used in the example 1 of the context retrieval procedure is provided with a function for requesting the context, it can be referred to as the context request message.

At step 352, the eNB 10 that receives the Context Request message retrieves the UE context of the UE 50 from a plurality of items of the UE context stored in the storage unit of the eNB 10 based on the information for identifying the UE context of the UE 50.

Then, at step S353, the eNB 10 transmits a Context Response message (a context response message) including the retrieved UE context to the eNB 20. Note that, since the Handover Request message used in the example 1 of the context retrieval procedure is provided with a function for responding to the context, it can be referred to as the context response message.

The eNB 20 that retrieves the UE context of the UE 50 resumes the bearer, etc.; and transmits, to the UE 50, the RRC Connection Resume Complete message including the Resume Id at step 354. In this manner, the UE 50 and the eNB 20 establish the connection between the UE 50 and the eNB 20 by reusing the UE context; and cause the state to transition to the RRC connected state.

Note that, if the eNB 20 executes the context retrieval procedure and the target UE context is not obtained (step 355), the RRC Connection Release message, for example, is transmitted so as to cause the UE 50 to transition to the RRC idle state. Note that, in this case, the RRC Connection Resume Complete message may be transmitted, or may not be transmitted.

### Embodiment 2

Next, the embodiment 2 is described. As described above, the embodiment 2 is a method that allows the amount of signaling to be reduced without defining a new state, such as the RRC-Suspended, by retaining, by the UE and the eNB, the UE context in the RRC idle state, and reusing the retained UE context when the state transitions to the RRC connected state. In the following, first, details of the method assumed in the embodiment are described; and then the context retrieval procedure, etc., in the method is described.

### Embodiment 2: An Example of Overall Sequence

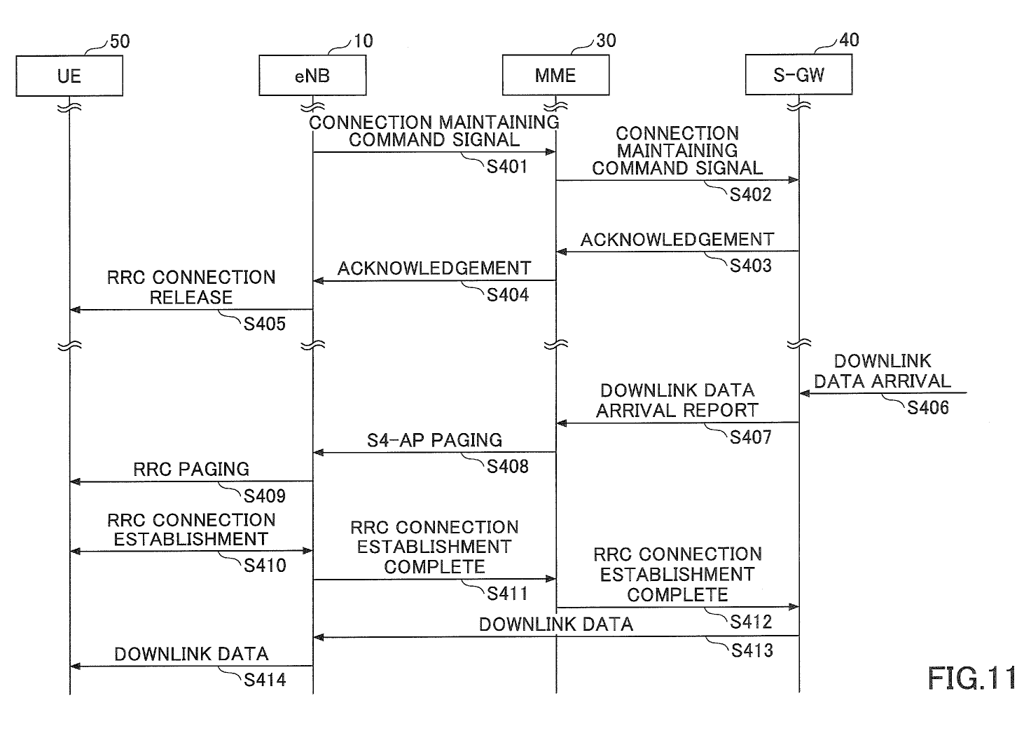

First, as an example of a sequence of the entire communication system in the embodiment 2, a method is described such that, when there is an incoming call to the UE 50 in the RRC idle state, paging is performed from the MME 30. More specifically, a processing sequence is described by referring to FIG. 11 for a case in which the UE 50 connects to the eNB 10 to be in the RRC connected state; the state transitions to the RRC idle state in a cell under control of the eNB 10; and an incoming call is received in the same cell.

As an assumption of the process of FIG. 11, the UE 50 is in the RRC connected state in the cell of the eNB 10; and it is in a state in which S1-C/U connections for the UE 50 are established. In FIG. 11, the S1-C connection includes a connection between the eNB 10 and the MME 30 and a connection between the MME 30 and the S-GW 40; and the S1-U connection includes a connection between the eNB 10 and the S-GW 40. When a connection is established, signals (data) related to the UE 50 can be communicated among the nodes without executing the procedure for connection setup, such as connection setup signals.

Before entering the description of the procedure of FIG. 11, an outline of an example of the procedure is described for the initial connection of the UE 50 to the eNB 10 (Non-Patent Document 4). Note that the procedure related to the initial connection can also be applied to the embodiment 1. At the time of the random access of the UE 50, the eNB 10 transmits the RRC Connection Setup to the UE 50 so as to cause the UE 50 to be in the RRC connected state; and receives the RRC Connection Setup Complete from the UE 50. After that, the eNB 10 receives the Initial Context Setup Request from the MME 30; transmits the RRC Security Mode Command to the UE 50; receives the RRC Security Mode Complete from the UE 50; then, transmits the RRC Connection Reconfiguration to the UE 50; receives the RRC Connection Reconfiguration Complete from the UE 50; and transmits the Initial Context Setup Response to the MME 30. Through such a procedure, the UE context is established and retained in each of the UE 50 and the eNB 10, for example.

As shown in FIG. 11, in the RRC connected state, the eNB 10 transmits, to the MME 30, the connection maintaining command signal (step 401). Furthermore, the MME 30 transmits the connection maintaining command signal to the S-GW 40 (step 402).

The connection maintaining command signal is a signal for indicating, at the time of receiving an incoming call to the UE 50, the MME 30 to hold downlink data in the S-GW 40 and to perform paging while maintaining the S1-C/U connections for the UE 50.

The S-GW 40 that receives the connection maintaining command signal transmits an acknowledgement indicating that the command is confirmed to the MME 30 (step 403); and the MME 30 transmits an acknowledgement to the eNB 10 (step 404).

The transmission of the connection maintaining command signal for the UE 50 from the eNB 10 to the MME 30 may be performed while being triggered, for example, by the fact that an event occurs in the eNB 10 that causes the UE 50 to transition to the RRC idle state; or may be performed immediately after the UE 50 initially transitions to the RRC connected state under control of the eNB 10 and the S1-C/U connections for the UE 50 are established.

The above-described event that causes the state to transition to the the RRC idle state is, for example, an event of detecting that communication with the UE 50 (uplink and downlink user data communication) has not occurred for a certain period of time by expiration of a predetermined timer (e.g., UE Inactivity Timer); however, it is not limited to this.

FIG. 11 assumes a case of being triggered by detecting that the communication with the UE 50 (uplink and downlink user data communication) has not occurred for the certain period of time; and the RRC Connection Release (RRC Connection Release) is transmitted to the UE 50 after steps 401 through 404, and the UE 50 is caused to transition to the RRC idle state (step 405).

Even if the UE 50 transitions to the RRC idle state, the UE context established at the time of the RRC connection is retained in each of the UE 50 and the eNB 10.

After that, downlink data for the UE 50 occurs, and the downlink data arrives at the S-GW 40 (step S406). Here, the S1-U connection has been established; however, based on the connection maintaining command signal received at step 402, the S-GW 40 reserves the downlink data in a buffer without transferring the downlink data to the eNB 10.

The S-GW 40 transmits a downlink data arrival report to the MME 30 (step 407); and the MME 30 transmits an S1-AP paging signal for the UE 50 to the eNB 10 (step 408). The paging itself is similar to the existing paging and it is transmitted to each eNB in a tracking area of the UE 50; however, transmission to the eNB 10 is illustrated in FIG. 11.

The eNB 10 that receives the S1-AP paging signal transmits a RRC paging signal to the subordinate UE 50 (step 409).

The UE 50 that receives the RRC paging signal executes the RRC connection establishment procedure and establishes the RRC connection (step 410). After that, the eNB 10 transmits, to the MME 30, the RRC connection establishment complete, which is a signal indicating that the establishment of the RRC connection is completed (step 411). Note that the eNB 10 can determine that the RRC connection to the UE 50 is established, for example, by receiving, by the eNB 10, the RRC Connection Setup Complete from the UE 50.

The MME 30 transmits a signal of the RRC connection establishment complete to the S-GW 40 (step 412). In this manner, the S-GW 40 determines that the RRC connection between the UE 50 and the eNB 10 is established; and starts transferring the reserved downlink data to the eNB 10 using the already-established S1-U connection for the UE 50 (step 413). The downlink data arrives at the UE 50 from the eNB 10 (step 414). In this manner, transmission of downlink data to the UE 50 is started.

Details of the RRC connection establishment procedure at step 410 of FIG. 11 are described below. In the RRC connection establishment procedure, each of the UE 50 and the eNB 10 utilizes the UE context that is established at the time of the RRC connection and that is retained, so that the RRC connection can be established without communicating messages, such as the RRC Security Mode Command, the RRC Security Mode Complete, the RRC Connection Reconfiguration, the RRC Connection Reconfiguration Complete, etc., which are usually required.

Here, the UE context that is retained in each of the UE 50 and the eNB 10 is, for example, the RRC configuration (RRC configuration), the bearer configuration (bearer configuration: including RoHC state information, etc.), the AS security context (Access Stratum Security Context), the L2/L1 parameter (e.g., configurations of MAC and PHY), etc.

Furthermore, the UE 50 and the eNB 10 may retain the same information as the UE context; or UE 50 may only retain information of the UE context required for a connection to the eNB 10, and the eNB 10 may only retain information of the UE context required for the connection to the UE 50.

More specifically, for example, each of the UE 50 and the eNB 10 may retain, as the UE context, the information of RadioResourceConfigDedicated transmitted in the RRC Connection Setup; the capability information transmitted in the RRC Connection Setup Complete; security related information (e.g., key information), the security related information transmitted in the RRC Security Mode Command; configuration information transmitted in the RRC Connection Reconfiguration, etc. Note that these are merely examples, and the information retained as the UE context is not limited to these; and information may be retained additionally, or a part of these information items may not be retained.

By retaining the above-described information items as the UE context, each of the UE 50 and the eNB 10 can establish, upon transitioning from the RRC idle state to the RRC connected state, the RRC connection without transmitting and receiving a message, such as RRC Security Mode Command, RRC Security Mode Complete, RRC Connection Reconfiguration, RRC Connection Reconfiguration Complete, etc.

Furthermore, in the embodiment 2, the eNB 10 stores the UE context in a storage unit while associating the UE context with the identifier of the UE (UE identifier) corresponding to the UE context. The type of the UE identifier is not limited; however, in the embodiment 2, as an example, S-TMSI (SAE temporary mobile subscriber identity) is used as the UE identifier.

<Example of the RRC Connection Establishment Procedure>

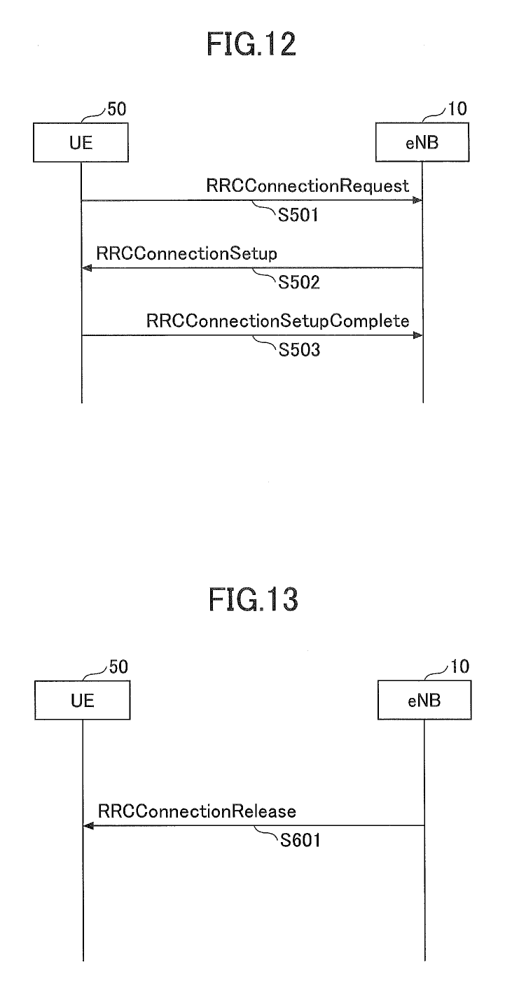

Next, the RRC connection establishment procedure between the UE 50 and the eNB 10 in the embodiment 2 is described by referring to the sequence of FIG. 12. Note that the sequence illustrated in FIG. 12 assumes the procedure of step 410 of FIG. 11; however, it is not limited to this. For example, the sequence illustrated in FIG. 12 may be a sequence in a RRC connection establishment procedure during call origination from the UE 50.

It is assumed that, prior to the sequence illustrated in FIG. 12, a Random Access Preamble is transmitted from the UE 50 to the eNB 10 and a Random Access Response is transmitted from the eNB 10 to the UE 50.

At step 501, the UE 50 transmits the RRC Connection Request message (RRC connection request) to the eNB 10 using a resource allocated by the UL grant included in the Random Access Response. In the embodiment 2, at step 501, the UE 50 reports to the eNB 10 that the UE 50 retains the UE context using a spare bit (spare bit: 1 bit) in the RRC Connection Request message. For example, if the bit is set (which is 1), it indicates that the UE 50 retains the UE context. The information indicating that the UE 50 retains the UE context is referred to as UE context retention information.

Furthermore, the RRC Connection Request message includes, in addition to the above-described bit, the UE identifier for identifying the UE 50 (specifically, S-TMSI (SAE temporary mobile subscriber identify). The S-TMSI is a temporary identifier of the UE 50 generated from an identifier unique to the UE 50; and it is provided by the MME 30 during location registration of the UE 50. In the embodiment, it is assumed that the UE 50 and each eNB retain the S-TMSI for identifying the UE 50.

At step 501, the eNB 1 that receives the above-described RRC Connection Request message finds that the UE 50 identified by the UE identifier retains the UE context by reading out the UE context retention information and the UE identifier from the message; and searches, in the storage unit, for the UE context corresponding to the UE identifier from a plurality of retained items of UE context. Namely, a matching process for the UE identifier is performed.

Upon detecting, at step 502, the UE context corresponding to the UE identifier as a result of the search, the eNB 10 reports, to the UE 50, that the eNB 10 retains the UE context of the UE 50 by the RRC Connection Setup message (RRC connection establishment message), and requests the UE 50 to transmit information for authenticating the UE 50. Here, a case is described in which the eNB 10 retains the UE context. The case in which the eNB 10 does not retain the UE context is described below.

The UE 50 that receives the RRC Connection Setup message including the information indicating that the UE context is retained continues to use the retained UE context (e.g., the bearer, the security key, and the configuration).

Furthermore, the RadioResourceConfigDedicated included in the RRC Connection Setup message includes parameter values related to the bearer, the MAC and PHY configuration, etc.; however, the UE 50 that receives, at step 502, the RRC Connection Setup message including the above-described report and request ignores the parameter values reported by the RadioResourceConfigDedicated, and continues using the parameter values of the retained UE context. Here, the reported parameter values may be used without ignoring the parameter values reported by the RadioResourceConfigDedicated. As a result, when the already retained parameter values are updated by the eNB 10, the update can be reflected.

Subsequently, at step 503, the UE 50 encloses authentication information, such as Authentication token and shortMAC-I, in the RRC Connection Setup Complete message, and transmits it to the eNB 10. Here, the authentication information, such as Authentication token and shortMAC-I, is information used for the eNB 10 to authenticate the UE 50.

The eNB 10 that receives the RRC Connection Setup Complete message authenticates that the UE 50 is the correct UE corresponding to the UE context retrieved by the UE identifier using the authentication information included in the message. After that, each of the UE 50 and the eNB 10 establishes (resumes) the connection utilizing the retained UE context. Note that, for establishing (resuming) the connection utilizing the retained UE context, step 503 may not be essential, and step 503 may not be executed.

<Example of the RRC Connection Release Procedure>

In the embodiment 2, when the UE 50 receives the RRC Connection Release message from the eNB 10 and transitions to the RRC idle state, the UE context may always be retained; or the UE context may be retained only if the RRC Connection Release message includes information indicating that the UE context is to be retained. The example of the latter is described below.

As illustrated in FIG. 13, when the eNB 10 causes the UE 50 to transition to the RRC idle state, the eNB 10 transmits the RRC Connection Release message to the UE 50 (step 601).

The RRC Connection Release message includes instruction information (indication) for indicating the UE 50 to keep retaining the UE context in the RRC idle state. Here, for the instruction information, a new indication may be included in the message, or a spare bit of the existing release cause may be used. A specific example is described below.

Upon detecting the instruction information in the RRC Connection Release message, the UE 50 continues to retain, during the RRC idle state, the UE context (the bearer information, the security information, etc.) at the time of transition to the RRC idle state.

### Embodiment 2: Another Example of Overall Sequence

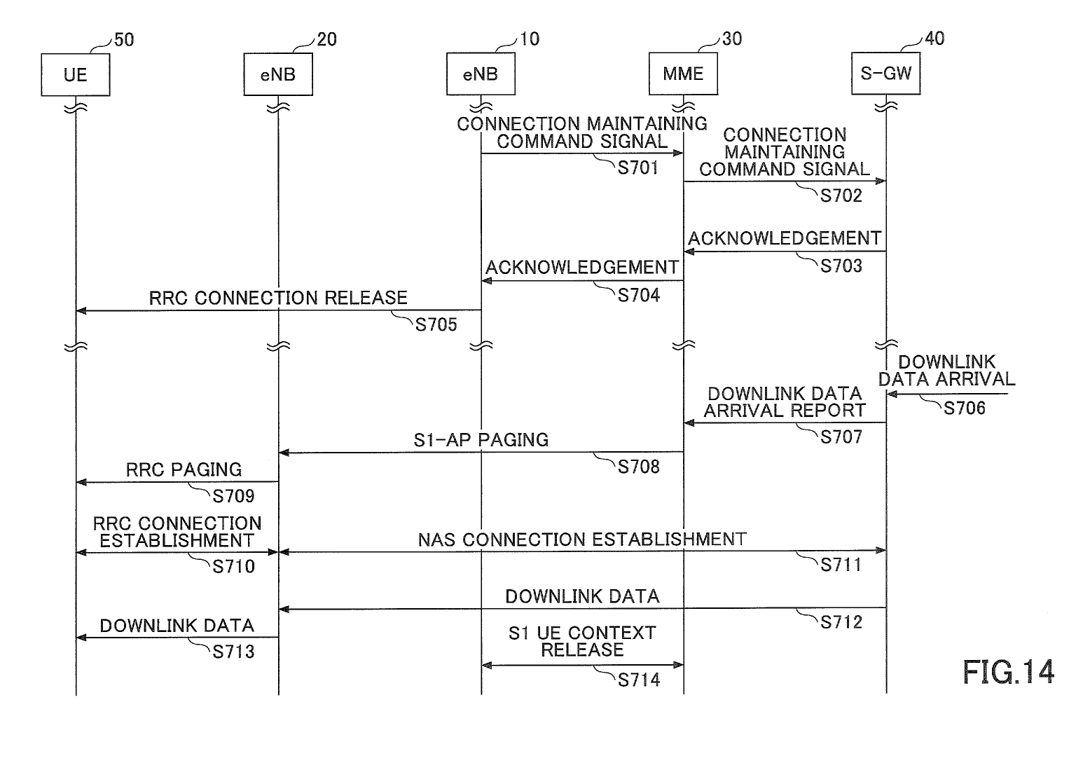

In the example illustrated in FIG. 11, the UE 50 transitions between the RRC connected state ant the RRC idle state under the same eNB 10; however, as another example, a processing sequence is described here by referring to FIG. 14 for a case in which the UE 50 connects to the eNB 10 to be in the RRC connected state; the state transitions to the RRC idle state in a cell under control of the eNB 10; and then the UE 50 moves to a cell under control of the eNB 20 and receives an incoming call.

Similar to FIG. 11, the eNB 10 transmits, to the MME 30, the connection maintaining command signal (step 701). Furthermore, the MME 30 transmits the connection maintaining command signal to the S-GW 40 (step 702).

The S-GW 40 that receives the connection maintaining command signal transmits an acknowledgement to the MME 30 (step 703); and the MME 30 transmits an acknowledgement to the eNB 10 (step 704).

After steps 701 through 704, the eNB 10 transmits the RRC Connection Release (RRC Connection Release) to the UE 50, and the UE 50 is caused to transition to the RRC idle state (step 705). After that, the UE 50 moves to a cell under control of the eNB 20. The RRC Connection Release message includes an indication to retain the UE context; and the UE 50 and the eNB 10 retain the UE context. Here, the UE context is the information used for connecting to the eNB 10.

After that, downlink data for the UE 50 occurs, and the downlink data arrives at the S-GW 40 (step 706). Here, the S1-U connection has been established; however, based on the connection maintaining command signal received at step 702, the S-GW 40 reserves the downlink data in a buffer without transferring the downlink data to the eNB 10.

The S-GW 40 transmits a downlink data arrival report to the MME 30 (step 707); and the MME 30 transmits an S1-AP paging signal for the UE 50 to the eNB 20 (step 708).

The eNB 20 that receives the S1-AP paging signal transmits a RRC paging signal to the subordinate UE 50 (step 709).

The UE 50 that receives the RRC paging signal executes the RRC connection establishment procedure and establishes the RRC connection (step 710). Furthermore, a NAS connection procedure is executed between the eNB 20 and the core NW side (the S-GW 40 in FIG. 14), and the S1-C/U connections for the eNB 20 are established (step 711).

As described above, the connection between the UE 50 and the S-GW-40 is established, so that the S-GW 40 starts transmitting the downlink data to the UE 50 (steps 712 and 713). Furthermore, the UE context is released between the eNB 10 and the MME 30, and the S1-C/U connections for the eNB 10 are released (step 714).

In the above-described example, the UE 50 transmits the message of step 501 of FIG. 12 in the RRC connection establishment procedure of step 710; however, the eNB 20 determines that the UE context corresponding to the UE 50 is not retained, so that the below-described context retrieval procedure is to be executed. Since the UE context obtained in the context retrieval procedure is utilized, the RRC connection between the eNB 20 and the UE 50 can be established while reducing the amount of signaling.

<Examples of the Change of the Specification>

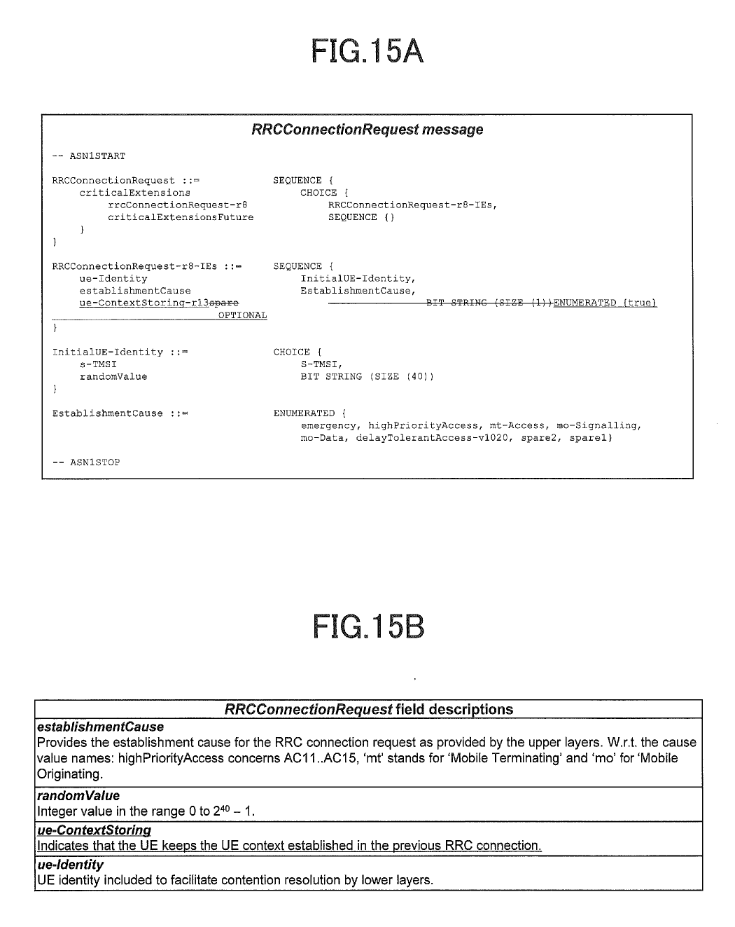

Next, examples of the description (extract) of the 3GPP specification (3GPP TS 36.331, Non-Patent Document 4) for performing various types of reporting described in FIG. 12 and FIG. 13 are shown in FIG. 15 through FIG. 19. In FIG. 15 through FIG. 19, the parts that are changed from Non-Patent Document 4 are underlined.

FIG. 15A shows an example of the RRC Connection Request message transmitted from the UE 50 at step 501 of FIG. 12. As shown in FIG. 15A, ue-ContextStoring (e.g., 1 bit) is added. As shown in FIG. 15B, ue-ContextStoring is information indicating that the UE 50 retains the UE context used in the previous RRC connection. Furthermore, as shown in FIG. 15A, S-TMSI is included.

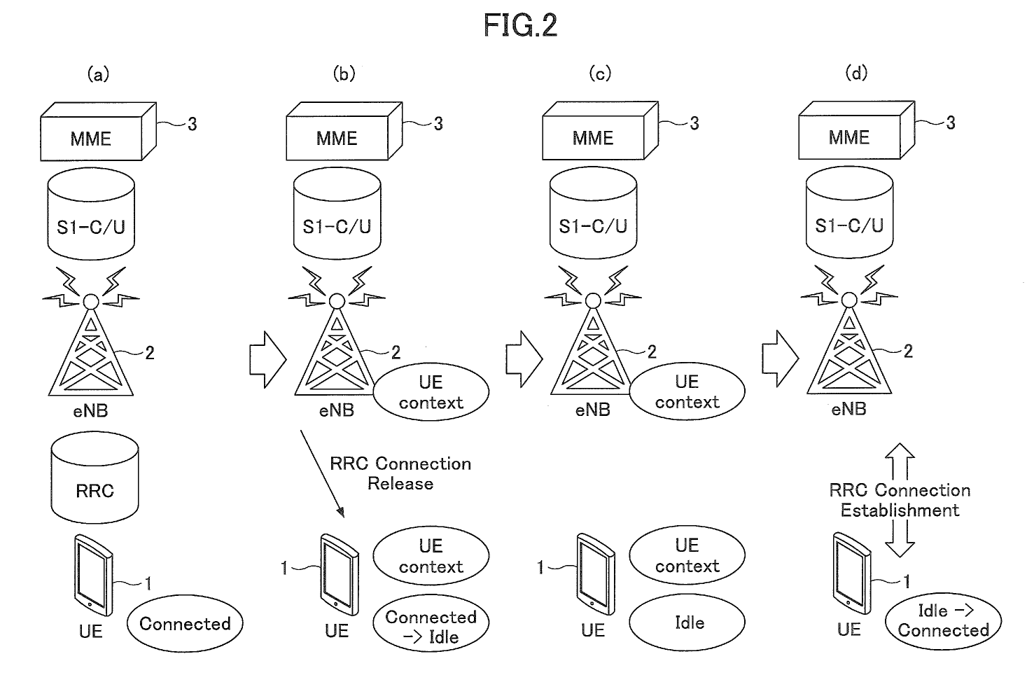

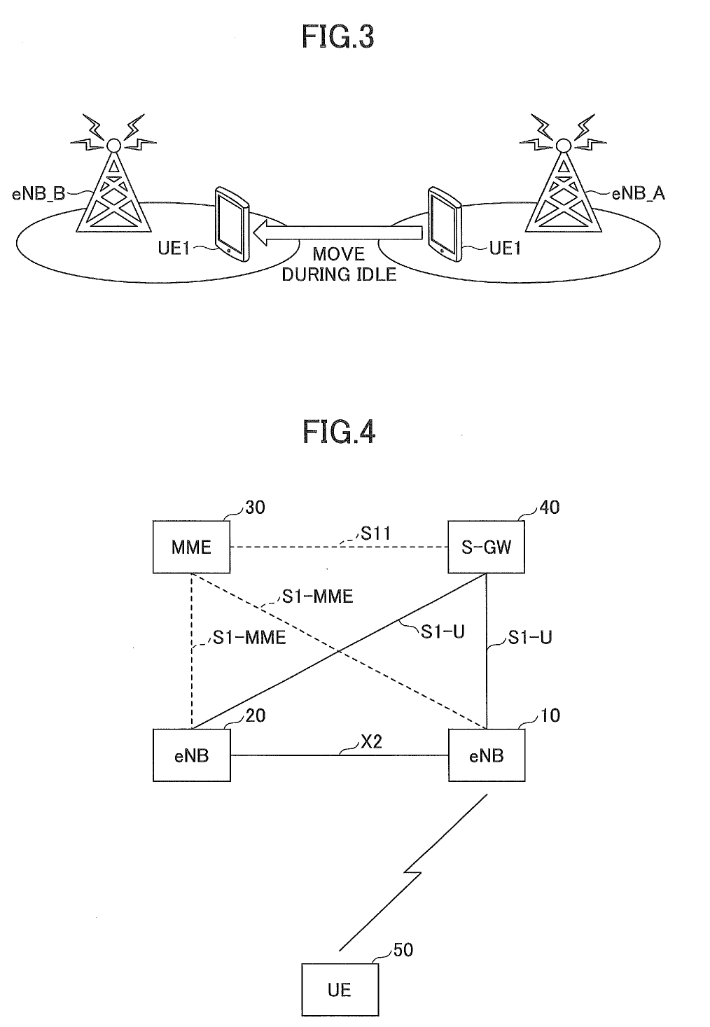

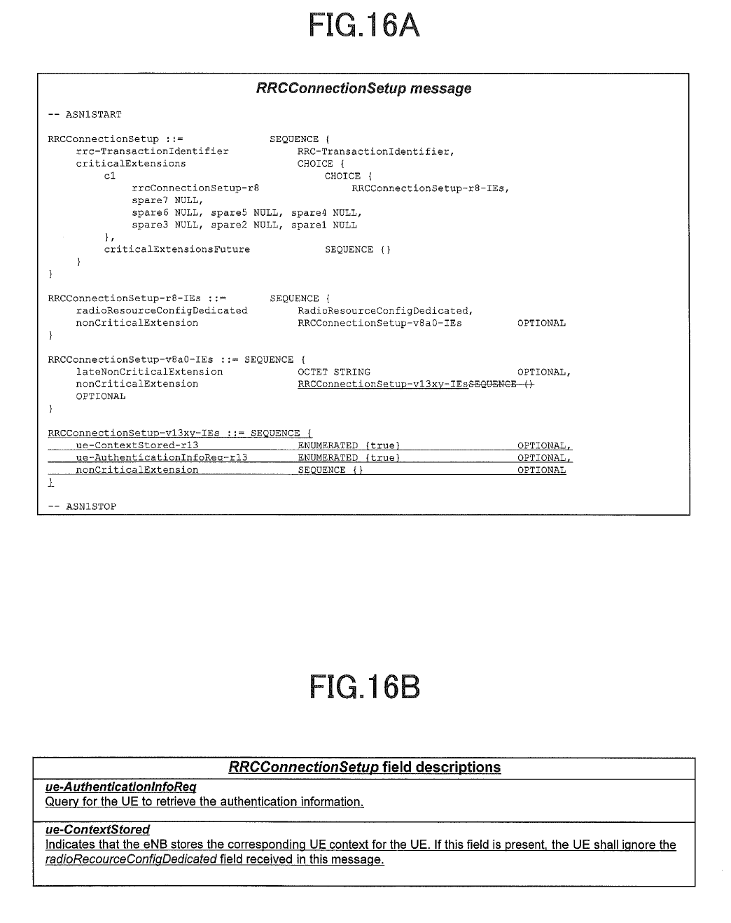

FIG. 16A shows an example of the RRC Connection Setup message transmitted from the eNB 10 at step 502 of FIG. 2. As shown in FIG. 16A, ue-ContextStored and ue-AuthenticationInfoReq are added.

As shown in FIG. 16B, ue-AuthenticationInfoReq is information for requesting the UE to transmit authentication information. The ue-ContextStored is information indicating that the eNB retains the UE context of the UE that is the target of the RRC Connection Setup. Upon detecting that this information (field) exists, the UE ignores the radioRecourceConfigDedicated field that is reported by the RRC Connection Setup message. Note that, as described above, the parameter values reported by this may be applied without ignoring the radioRecourceConfigDedicated field.

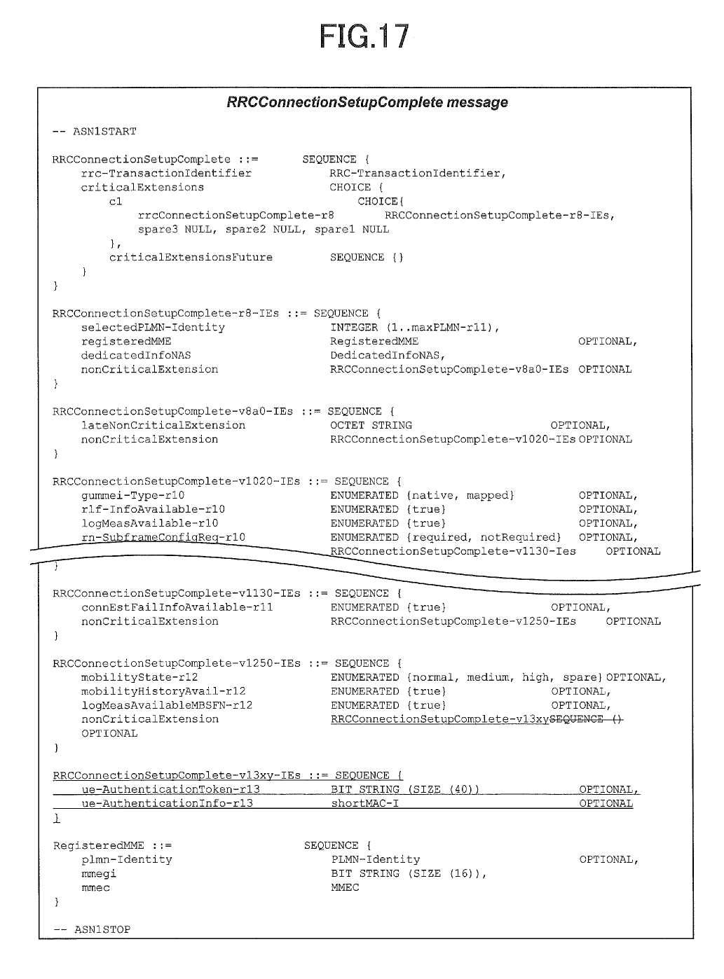

FIG. 17 shows an example of the RRC Connection Setup Complete message that is transmitted from the UE 50 at step 503 of FIG. 12. As shown in FIG. 17, ue-AuthenticationToken and ue-AuthenticationInfo are added, which are the authentication information.

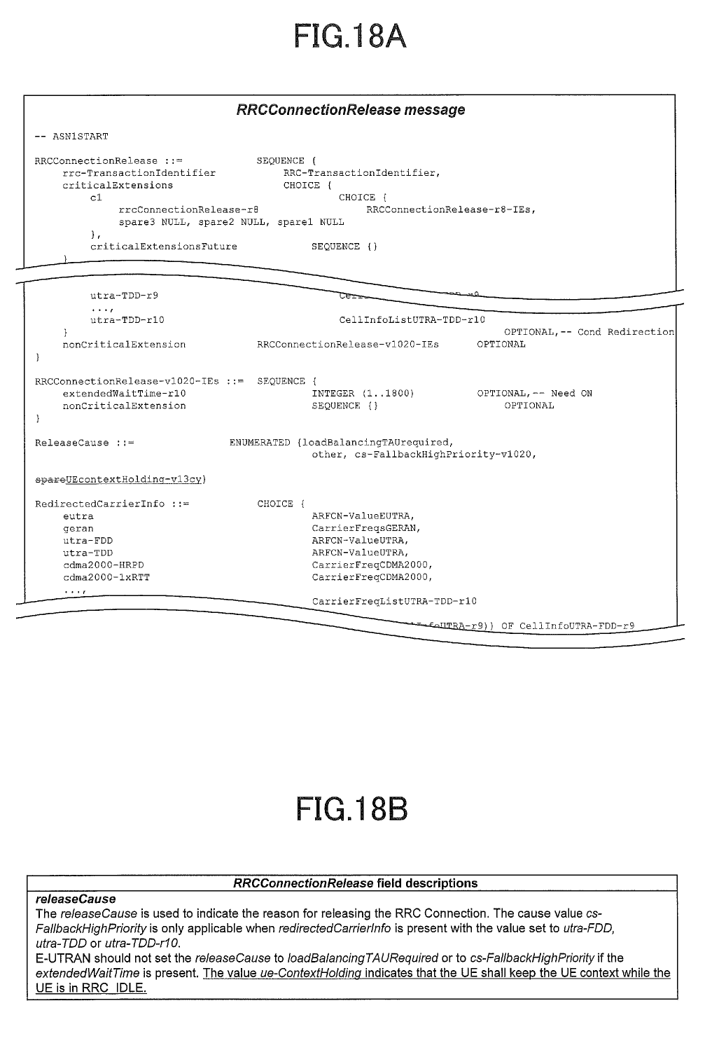

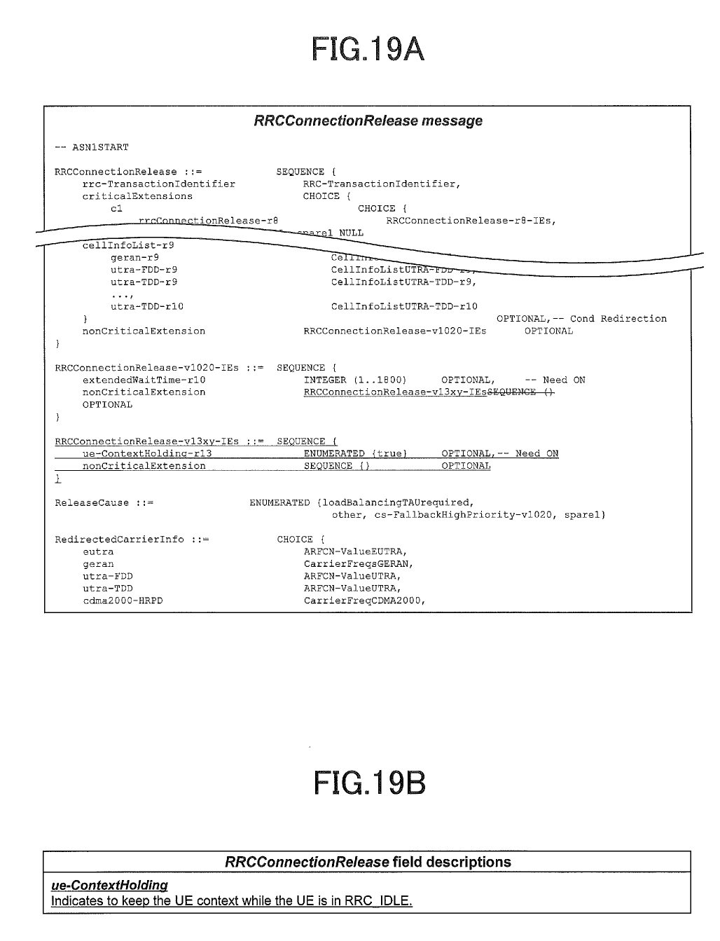

FIG. 18 through FIG. 19 show examples 1 and 2 of the RRC Connection Release message transmitted form the eNB 10 at step 601 of FIG. 13.

FIGS. 18A and 18B show the example (the example 1) for making the UE context retention indication using Cause value. In this case, as shown in FIG. 18A, UEcontextHolding is added in Release Cause. As illustrated in FIG. 18B, the value of ue-ContextHolding shows an indication to continue retaining the UE context while the UE is in the RRC idle state.

FIGS. 19A and 19B show the example (the example 2) for making the UE context retention indication using a new indication. As shown in FIG. 19A, ue-ContextHolding is added as the new indication. As shown in FIG. 19B, ue-ContextHolding shows an indication to continue retaining the UE context while the UE is in the RRC idle state.

### Embodiment 2: An Example of the Procedure Between the UE 50 and the eNB 20

In the following, the process for the eNB 20 to obtain the UE context is described for a case in which the UE 50 transitions from the RRC connected state to the RRC idle state under control of the eNB 10, and then the UE 50 moves to a cell under control of the eNB 20, which is different from the eNB 10 (e.g., the case illustrated in FIG. 14). Note that each of the eNB 10 and the eNB 20 is provided with a context retention function; and is provided with a function for executing the context retrieval procedure, as described below.

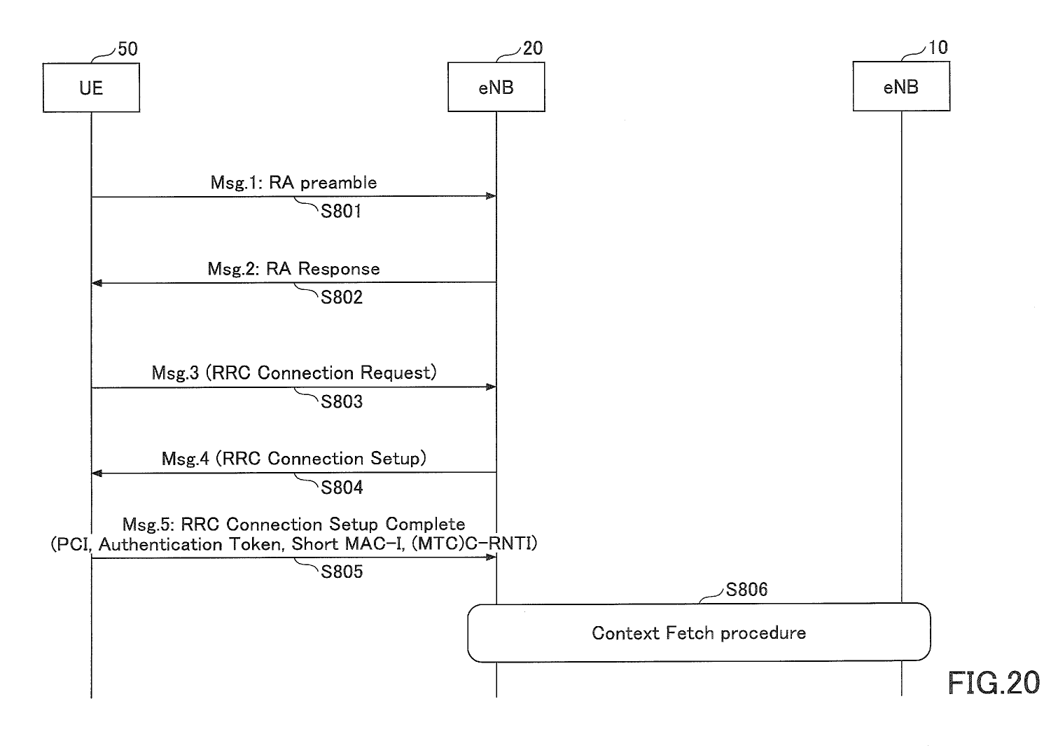

First, a processing procedure between the UE 50 and the eNB 20 is described by referring to FIG. 20. As an assumption of the process of FIG. 20, the UE 50 is in the RRC idle state and retains the UE context at the time of connecting to the eNB 10. Then, a situation is assumed such that the UE 50 moves to a cell under control of the eNB 20 while keeping the RRC idle state; and triggered by originating a call, or triggered by receiving an incoming call, a procedure for transition to the RRC connected state is activated. Furthermore, the operation described below is based on the operation described by referring to FIG. 12; however, unlike the case of FIG. 12, the following operation is the operation when the eNB 20 does not retain the UE context of the UE 50.

At step 801, a Random Access Preamble is transmitted from the UE 50 to the eNB 20; and, at step 802, a Random Access Response is returned from the eNB 20 to the UE 50.

At step 803, the UE 50 transmits a RRC Connection Request message to the eNB 20.

The RRC Connection Request message includes information indicating that the UE 50 retains the UE context and a UE identifier (S-TMSI). The eNB 20 that receives the RRC Connection Request message searches for the UE context of the UE 50 that is stored while being associated with the UE identifier included in the message; however, the eNB 20 may not detect the UE context of the UE 50.

Consequently, at step 804, the eNB 20 transmits, to the UE 50, a RRC Connection Setup message including information that indicates that the UE context of the UE 50 does not exist in the eNB 20 (or it does not include information indicating that the UE context of the UE 50 exists in the eNB 20).

Upon receiving a message including the above-described information, the UE 50 finds that the eNB 20 does not retain the UE context and transmits, at step 805, a RRC Connection Setup Complete message to the eNB 20 so as to cause the eNB 20 to execute the context retrieval procedure (Context Fetch procedure).

The message to be transmitted at step 805 includes information for identifying an eNB (which is the eNB 10 here) that retains the eNB side UE context corresponding to the UE context retained by the UE 50; and information for identifying (and/or authenticating) that the UE context is for the UE 50 (information for identifying the UE context of the UE 50). Description of the specific contents of the information is the same as that of the embodiment 1.

The eNB 20 that receives the message of step 805 executes the context retrieval procedure with the eNB 10 identified by the PCI, etc., (step 806).

Note that, in the above-described example, the information indicating whether the eNB 20 retains the UE context is reported to the UE 50; however, such reporting may not be performed. In this case, the UE 50 transmits identification information for identifying the UE context (e.g., Authentication Token, Short MAC-I, (MTC)C-RNTI) to the eNB 20, regardless of whether the eNB 20 retains the UE context. Upon detecting that the own device does not retain the UE context corresponding to the identification information, the eNB 20 executes the context retrieval procedure (context fetch procedure) described below.

### Embodiment 2: Example 1 of the Context

### Retrieval Procedure

Next, an example 1 of the context retrieval procedure and an example 2 of the context retrieval procedure are described for the example of the context retrieval procedure illustrated in FIG. 20. The example 1 of the context retrieval procedure is an example of a procedure utilizing a message related to inter-eNB communication using the X2 interface, which is described in Non-Patent Document 5, etc.; and the example 2 of the context retrieval procedure is an example of a procedure using a new message using the X2 interface.

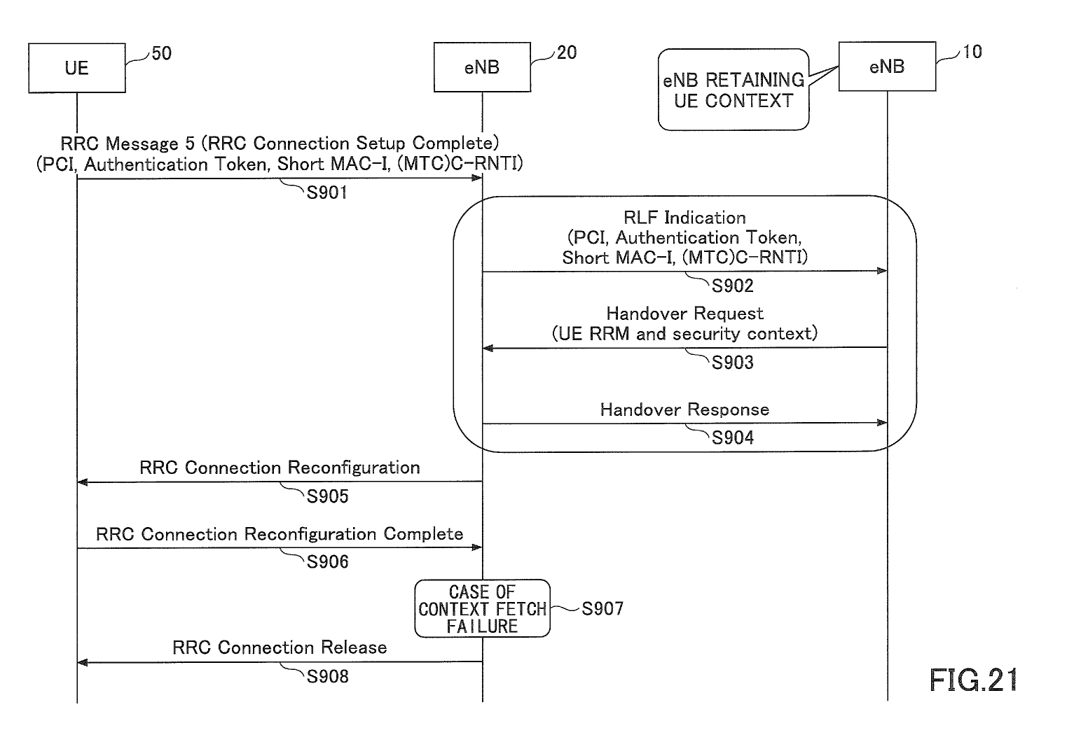

First, the example 1 of the content retrieval procedure is described by referring to FIG. 21. At step 901, the UE 50 transmits a RRC Connection Setup Complete message to the eNB 20. The information for identifying the eNB retaining the UE context of the UE 50 (here, the eNB 10) and the information for identifying the UE context of the UE 50 are included in the RRC Connection Setup message. Specifically, as described above, PCI, Authentication Token, Short MAC-I, and (MTC)C-RNTI are included.

At step 902, the eNB 20 transmits a RLF Indication (Radio Link Failure Indication: radio link failure indication) message to the eNB 10 identified by the PCI. The information for identifying the eNB retaining the UE context of the UE 50 received from the UE 50 (here, the eNB 10) and the information for identifying the UE context of the UE 50 are included in the RLF Indication message. Namely, PCI, Authentication Token, Short MAC-I, and (MTC)C-RNTI are included.

At step 902, the eNB 10 that receives the RLF Indication message retrieves the UE context of the UE 50 from a plurality of items of the UE context stored in the storage unit of the eNB 10 based on the information for identifying the UE context of the UE 50.

Then, at step S903, the eNB 10 transmits a Handover Request message including the retrieved UE context to the eNB 20. The eNB 20 that receives the Handover Request message returns, at step 904, the Handover Response message to the eNB 10.

The eNB 20 that retrieves the UE context of the UE 50 transmits the RRC Connection Reconfiguration message to the UE 50 at step 905. Furthermore, at step 906, the UE 50 transmits the RRC Connection Reconfiguration Complete message to the eNB 20. In this manner, the UE 50 and the eNB 20 establish the connection between the UE 50 and the eNB 20 by reusing the UE context; and cause the state to transition to the RRC connected state.

Note that the UE 50 and the eNB 20 can establish the RRC connection between the UE 50 and the eNB 20 by reusing the retained/retrieved UE context, so that step 905 and the step 906 may not be executed. Alternatively, the UE 50 may ignore a part of or all of the configuration information received in the RRC Connection Reconfiguration message. Furthermore, the configuration information received in the RRC Connection Reconfiguration message may be applied without ignoring it.

Note that, if the eNB 20 executes the context retrieval procedure and the target UE context is not obtained (step 907), the RRC Connection Release message, for example, is transmitted so as to cause the UE 50 to transition to the RRC idle state.

### Embodiment 2: Example 2 of the Context Retrieval Procedure

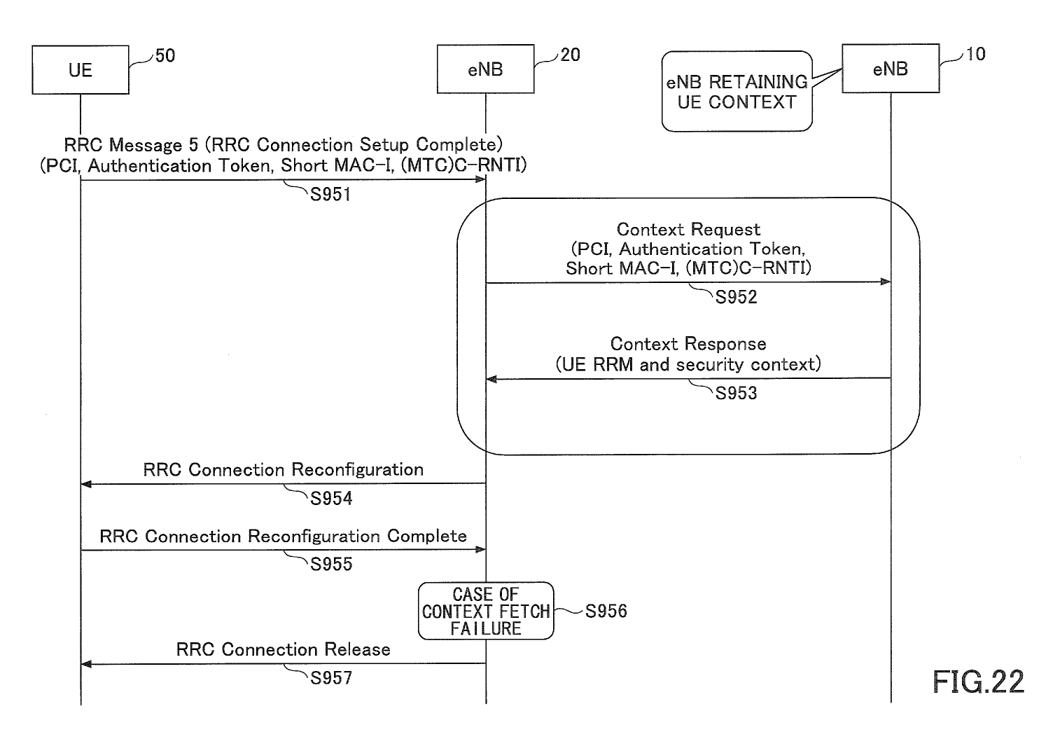

Next, the example 2 of the context retrieval procedure is described by referring to FIG. 22. At step 951, the UE 50 transmits a RRC Connection Setup Complete message to the eNB 20. The information for identifying the eNB retaining the UE context of the UE 50 (here, the eNB 10) and the information for identifying the UE context of the UE 50 are included in the RRC Connection Setup Complete message. Specifically, as described above, PCI, Authentication Token, Short MAC-I, and (MTC)C-RNTI are included.

At step 952, the eNB 20 transmits a Context Request message (a context request message) to the eNB 10 identified by the PCI. The information for identifying the eNB retaining the UE context of the UE 50 received from the UE 50 (here, the eNB 10) and the information for identifying the UE context of the UE 50 are included in the Context Request message. Namely, PCI, Authentication Token, Short MAC-I, and (MTC)C-RNTI are included. Note that, since the RLF Indication message used in the example 1 of the context retrieval procedure is provided with a function for requesting the context, it can be referred to as the context request message.

At step 952, the eNB 10 that receives the Context Request message retrieves the UE context of the UE 50 from a plurality of items of the UE context stored in the storage unit of the eNB 10 based on the information for identifying the UE context of the UE 50.

Then, at step S953, the eNB 10 transmits a Context Response message (a context response message) including the retrieved UE context to the eNB 20. Note that, since the Handover Request message used in the example 1 of the context retrieval procedure is provided with a function for responding to the context, it can be referred to as the context response message.

The eNB 20 that retrieves the UE context of the UE 50 transmits, at step 954, the RRC Connection Reconfiguration message to the UE 50. Furthermore, at step 955, the UE 50 transmits the RRC Connection Reconfigurartion Complete message to the eNB 20. In this manner, the UE 50 and the eNB 20 establish the connection between the UE 50 and the eNB 20 by reusing the UE context; and cause the state to transition to the RRC connected state.

Note that the UE 50 and the eNB 20 can establish the RRC connection between the UE 50 and the eNB 20 by reusing the retained/retrieved UE context, so that step 954 and step 955 may not be executed. Alternatively, the UE 50 may ignore a part of or all of the configuration information received in the RRC Connection Reconfiguration message. Furthermore, the configuration information received in the RRC Connection Reconfiguration message may be applied without ignoring it.

Note that, if the eNB 20 executes the context retrieval procedure and the target UE context is not obtained (step 956), the RRC Connection Release message, for example, is transmitted so as to cause the UE 50 to transition to the RRC idle state (step 957).

### Embodiment 2: A Modified Example 1 of the Method of Reporting the Identification Information of the eNB

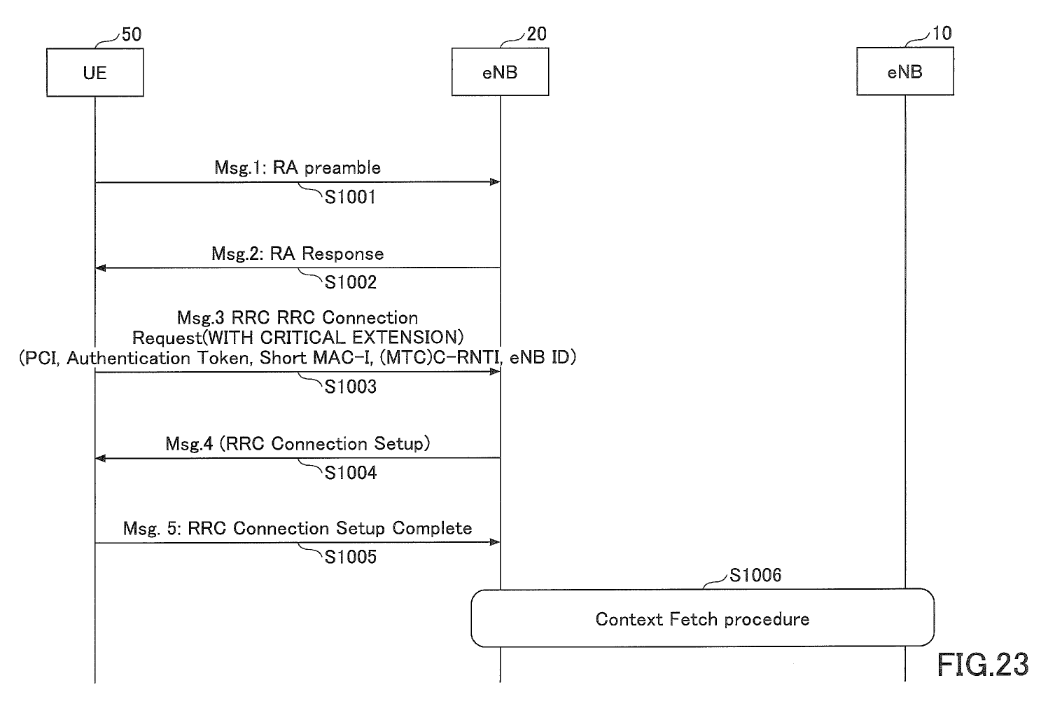

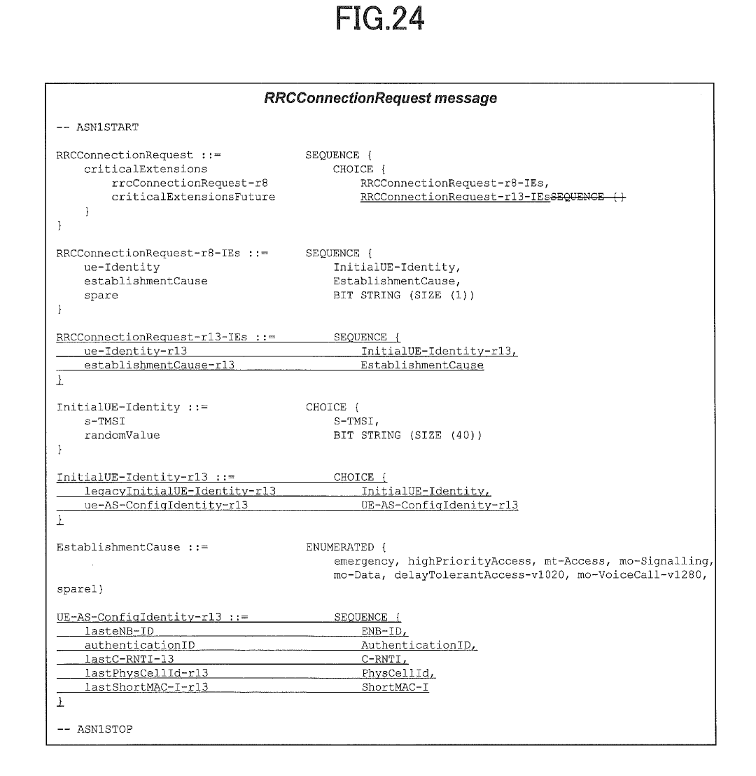

In the method described by referring to FIG. 20 in the embodiment 2, the identification information of the eNB is included in the RRC Connection Setup Complete message to be transmitted; however, this is an example, and the identification information of the eNB can be transmitted in another message. In the modified example 1, the identification information of the eNB is included in the RRC Connection Request message, and it is transmitted. The modified example 1 is described by referring to FIG. 23 and FIG. 24.

As an assumption of the process of FIG. 23, the UE 50 is in the RRC idle state and retains the UE context at the time of connecting to the eNB 10. Then, a situation is assumed such that the UE 50 moves to a cell under control of the eNB 20 while keeping the RRC idle state; and triggered by originating a call, or triggered by receiving an incoming call, a procedure for transition to the RRC connected state is activated.

At step 1001, a Random Access Preamble is transmitted from the UE 50 to the eNB 20; and, at step 1002, a Random Access Response is returned from the eNB 20 to the UE 50.

At step 1003, the UE 50 transmits a RRC Connection Request message to the eNB 20. The message transmitted at step 1003 includes information for identifying the eNB (here, the eNB 10) retaining the eNB side UE context corresponding to the UE context retained by the UE 50 and information for identifying (and/or authenticating) that the UE context is for the UE 50 (information for identifying the UE context of the UE 50). Description of the specific contents of the information is the same as that of the embodiment 1. In the example of FIG. 23, both the PCI and the eNB ID are included; however, only one of them may be included.

At step 1004, the eNB 20 transmits the RRC Connection Setup message to the UE 50. At step 1005, the UE 50 transmits the RRC Connection Setup Complete message to the eNB 20.

At step 1006, the eNB 20 executes the context retrieval procedure with the eNB 10 identified by the PCI, etc. The details of the context retrieval procedure are the same as those described by referring to FIG. 21 and FIG. 22.

FIG. 24 shows an example of a description (extraction) of the 3GPP specification (3GPP TS 36.331, Non-Patent Document 4) for transmitting the RRC Connection Request message in step S1003.

As shown in FIG. 24, RRCConnectionRequest-r13-IEs are added as criticalExtensionsFuture. The RRCConnectionRequest-r13-IEs include UE-AS-ConfigIdenity-r13; and UE-AS-ConfigIdenity-r13 includes the Authentication Token ID, the eNB-ID at the time of the previous connection (at the time of connecting to the eNB 10), the C-RNTI, the PCI, and the Short MAC-I.

### Embodiment 2: A Modified Example 2 of the Method of Reporting the Identification Information of the eNB

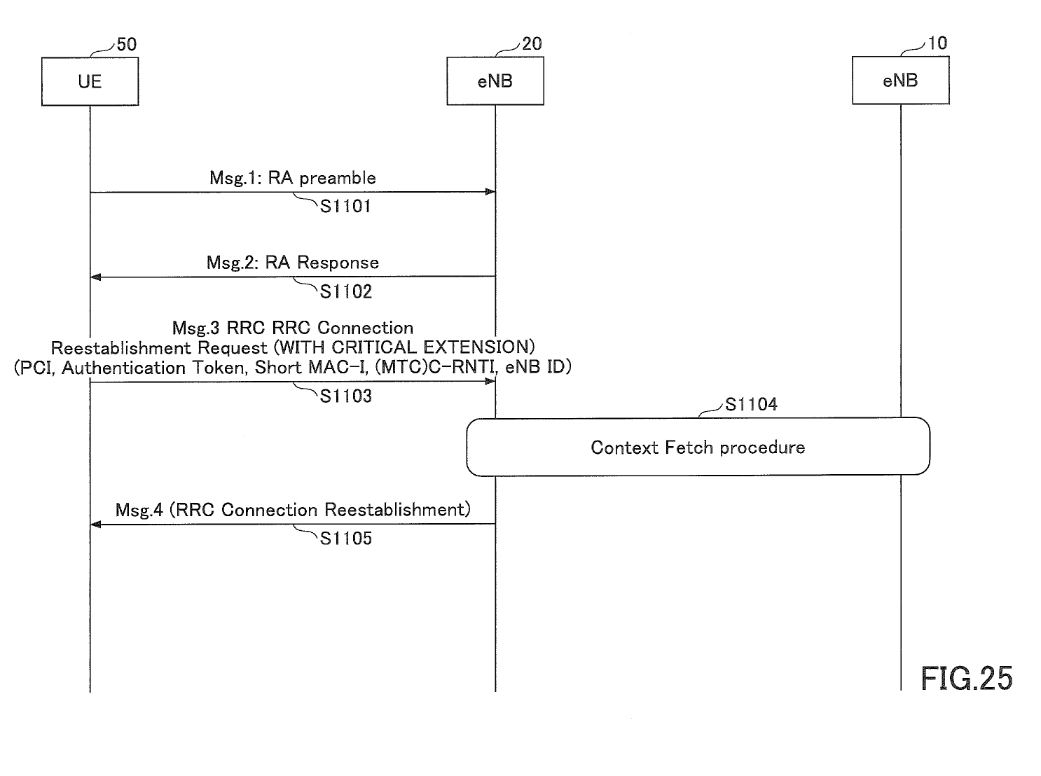

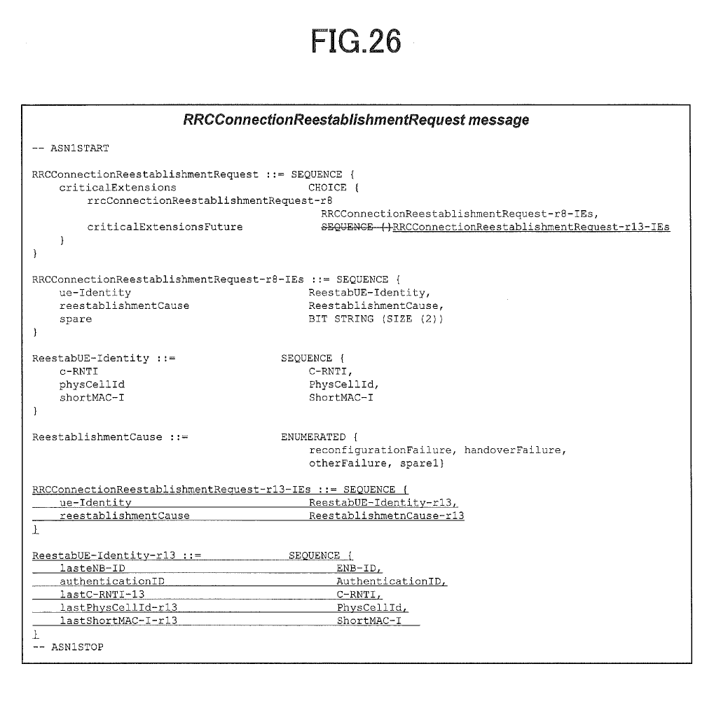

In the modified example 2, the identification information of the eNB is included in the RRC Connection Reestablishment Request message, and it is transmitted. The modified example 2 is described by referring to FIG. 25 and FIG. 26. Note that the RRC Connection Reestablishment (connection reestablishment) procedure is a procedure that is to be executed for a case, such as a radio link failure (radio link failure) and a handover failure (Handover failure).

As an assumption of the process of FIG. 23, the UE 50 retains the UE context at the time of connecting to the eNB 10. Then, a situation is assumed such that the UE 50 moves to a cell under control of the eNB 20 while keeping the RRC idle state; and a radio link failure occurs.

At step 1101, a Random Access Preamble is transmitted from the UE 50 to the eNB 20; and, at step 1102, a Random Access Response is returned from the eNB 20 to the UE 50.

At step 1103, the UE 50 transmits a RRC Connection Reestablishment Request message to the eNB 20. The message transmitted at step 1103 includes information for identifying the eNB (here, the eNB 10) retaining the eNB side UE context corresponding to the UE context retained by the UE 50 and information for identifying (and/or authenticating) that the UE context is for the UE 50 (information for identifying the UE context of the UE 50). Description of the specific contents of the information is the same as that of the embodiment 1. In the example of FIG. 24, both the PCI and the eNB ID are included; however, only one of them may be included.

At step 1104, the eNB 20 executes the context retrieval procedure with the eNB 10 identified by the PCI, etc. The details of the context retrieval procedure are the same as those described by referring to FIG. 21 and FIG. 22.

The eNB 20 that retrieves the UE context by the context retrieval procedure transmits, at step 1105, the RRC Connection Reestablishment message to the UE 50.

Note that, since the UE 50 retains the context, the UE 50 may ignore a part of or all of the configuration information (e.g., radio ResourceConfigDedicated) received in the RRC Connection Reestablishment message. Furthermore, the configuration information received in the RRC Connection Reestablishment message may be applied without ignoring it.

FIG. 26 shows an example of a description (extraction) of the 3GPP specification (3GPP TS 36.331, Non-Patent Document 4) for transmitting the RRC Connection Reestablishment Request message in step S1103.

As shown in FIG. 26, RRCConnectionReestablishmentRequest-r13-IEs are added as criticalExtensionsFuture. The RRCConnectionReestablishmentRequest-r13-IEs include ReestabUE-Identity-r13; and ReestabUE-Identity-r13 includes the Authentication Token ID, the eNB-ID at the time of the previous connection (at the time of connecting to the eNB 10), the C-RNTI, the PCI, and the Short MAC-I.

### Device Configuration Example

Next, configuration examples of devices according to the embodiments of the present invention are described. In the configuration of each device described below shows only functional units particularly related to the embodiments of the present invention; and it includes at least functions, which are not depicted, for operating as a device of a communication system conforming to LTE (LTE that means to include EPC). Furthermore, the functional configurations shown in the respective drawings are merely examples. The functional division and the names of the functional units may be any division and names, provided that the operation according to the embodiments can be executed.

Each device may include functions of both the embodiment 1 and the embodiment 2; or may include one of the embodiment 1 and the embodiment 2. In the following description, it is assumed that each device is provided with the functions of both the embodiment 1 and the embodiment 2.

<Examples of Configurations of the MME and the S-GW>

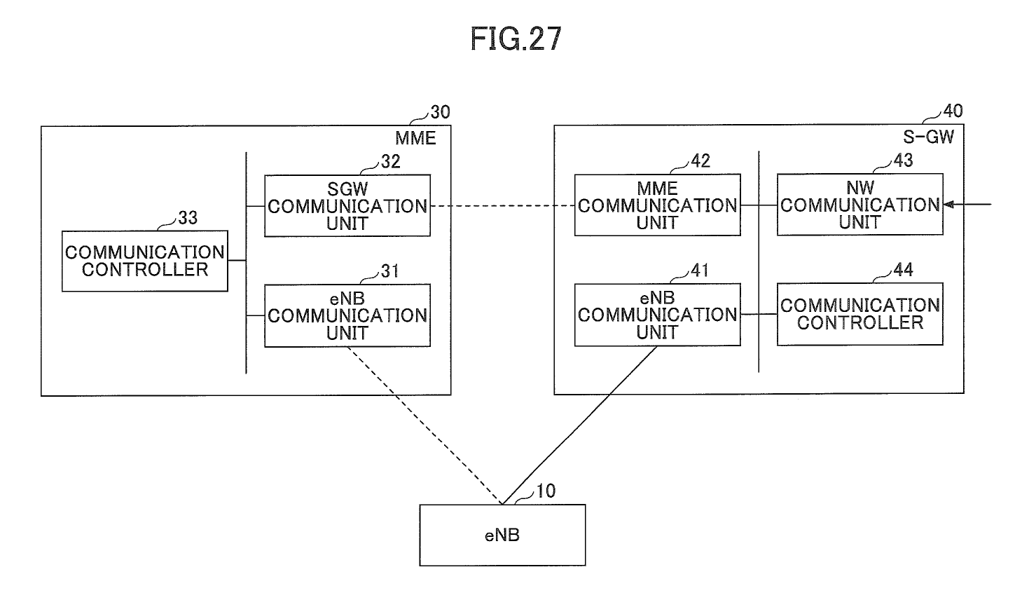

First, examples of configurations of the MME and the S-GW are described by referring to FIG. 27. As illustrated in FIG. 27, the MME 30 includes an eNB communication unit 31; a SGW communication unit 32; and a communication controller 33.

The eNB communication unit 31 includes a function for communicating control signals with an eNB via the S1-MME interface. The SGW communication unit 32 includes a function for communicating control signals with the S-GW via the S11 interface.

Furthermore, the S-GW 40 includes an eNB communication unit 41; a MME communication unit 42, a NW communication unit 43; and a communication controller 44. The eNB communication unit 41 includes a function for communicating data with an eNB via the S1-U interface. The MME communication unit 42 includes a function for communicating control signals with a MME via the S11 interface. The NW communication unit 43 includes a function for communicating control signals and communicating data with a node device at the core NW side.

Note that the description so far is common to the first embodiment and the second embodiment. In the following, the function of the embodiment 2 (the method that is different from that of Non-Patent Document 3) is particularly described.

The communication controller 33 includes a function for indicating, upon receiving a connection maintaining command signal from the eNB, to the SGW communication unit 32 to transmit the connection maintaining command signal to the S-GW, and for indicating, upon receiving an acknowledgement signal from the S-GW, to the SGW communication unit 32 to transmit the acknowledgement signal to the eNB.

The communication controller 44 includes a function for indicating, upon receiving a connection maintaining command signal from the MME, to the MME communication unit 42 to transmit an acknowledgement signal to the MME. Furthermore, the communication controller 44 includes a function for indicating, when a connection maintaining signal is received from the MME and downlink data to the UE is received, to the NW communication unit 43 to reserve the downlink data in a buffer; and for indicating, when the RRC connection establishment complete is received from the eNB, to the NW communication unit 43 to transmit the downlink data.

Note that the MME 30 and the S-GW 40 can be configured as a single device. In that case, the communication between the SGW communication unit 32 and the MME communication unit 42 via the S11 interface is communication inside the device.

Next, examples of configurations of the UE 50 and the eNB 10 according to the embodiment (which includes the embodiment 1 and the embodiment 2) of the present invention are described. Note that the eNB 10 and the eNB 20 are provided with the same functions, so that the eNB 10 is exemplified here.

<User Equipment>

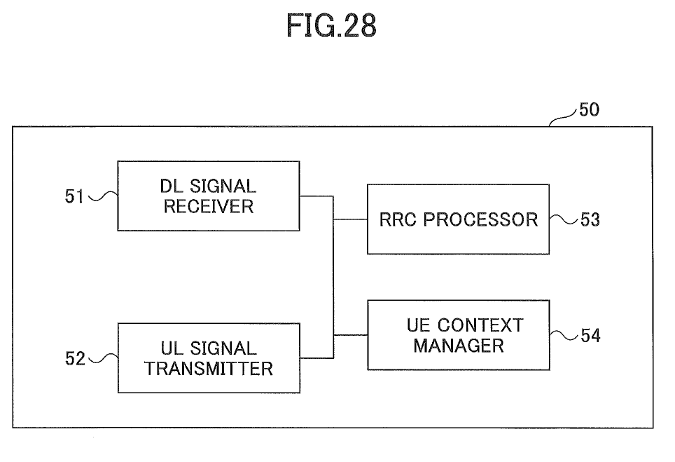

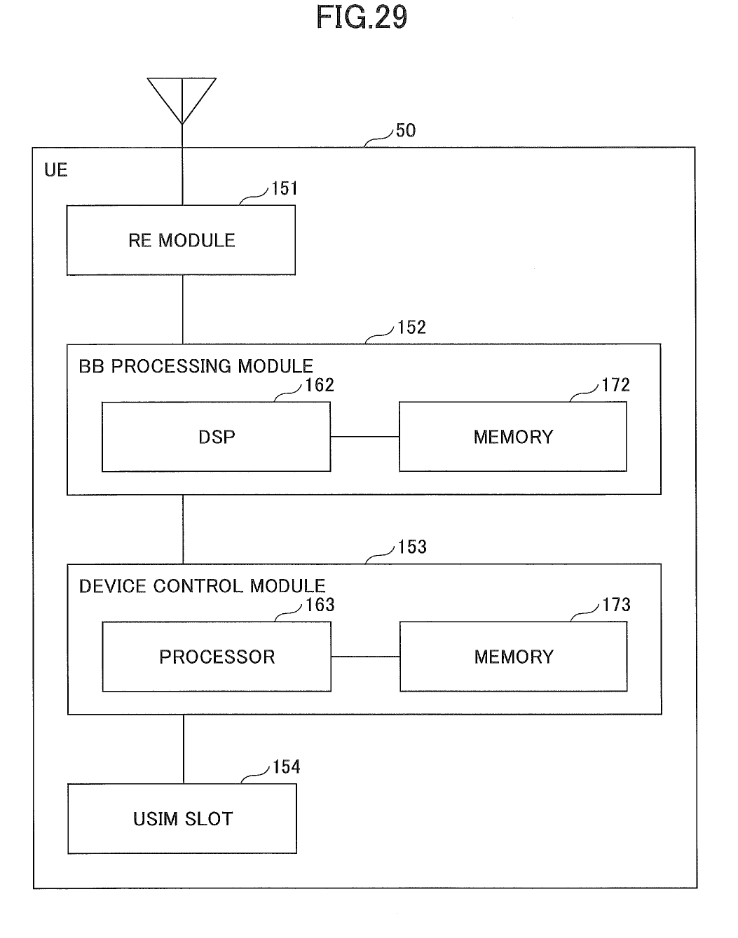

FIG. 28 shows a functional configuration diagram of the user equipment (UE50). As illustrated in FIG. 28, the UE 50 includes a DL signal receiver 51; a UL signal transmitter 52; a RRC processor 53; and a UE context manager 54. Note that, FIG. 28 only illustrates, in the UE 50, the functional units that are particularly related to the present invention; and the UE 50 also includes, at least, functions, which are not depicted, for performing operations conforming to LTE.

The DL signal receiver 51 includes a function for receiving various types of downlink signals from the base station eNB and for retrieving higher layer information from the received physical layer signals; and the UL signal transmitter 52 includes a function for generating various types of physical layer signal from higher layer signals to be transmitted from the UE 50, and for transmitting them to the base station eNB.

The RRC processor 53 performs the determination process at the UE side, generation and transmission of RRC messages (the transmission is through the UL signal transmitter 52), and parsing the RRC messages received by the DL signal receiver 51, which are described by referring to FIGS. 7 through 10, FIG. 12, FIG. 13, and FIG. 15 through 26, etc. Furthermore, the RRC processor 53 also includes, for example, a function for resuming the RRC connection using the UE context retained in the UE context manager 54.

The UE context manager 54 includes a storage unit, such as a memory; and retains the UE context and the UE identifier (e.g., S-TMSI) in the RRC suspension state/RRC idle state based on the indication described, for example, in step 107 of FIG. 5 and FIG. 13. Furthermore, in the procedure illustrated in FIG. 12, it determines whether the UE context is retained; and if the UE context is retained, it indicates the RRC processor 53 to report the information indicating that the UE context is retained.

The entire configuration of the UE 50 illustrated in FIG. 28 may be implemented by a hardware circuit (example: one or more IC chips); or a part of it may be configured by a hardware circuit, and the other part may be implemented by a CPU and a program.

FIG. 29 is a diagram illustrating an example of a hardware (HW) configuration of the UE 50. FIG. 29 shows a configuration closer to an implementation example compared to FIG. 28. As illustrated in FIG. 29, the UE includes an RE (Radio Equipment) module 151 that executes a process related to a radio signal; a BB (Base Band) processing module 152 that performs baseband signal processing; a device control module 153 that performs a process of a higher layer, etc.; and a USIM slot 154 that is an interface for accessing a USIM card.

The RE module 151 generates a radio signal to be transmitted from an antenna by applying a D/A (Digital-to-Analog) conversion; modulation; a frequency conversion; power amplification, and so forth to a digital baseband signal received from the BB processing module 152. Additionally, a digital baseband signal is generated by applying a frequency conversion, an A/D (Analog to Digital) conversion, demodulation, and so forth to a received radio signal; and it is passed to the BB processing module 152. The RE module 151 include, for example, functions of the physical layer, etc., in the DL signal receiver 51 and the UL signal transmitter 52 of FIG. 28.

The BB processing module 152 executes a process of mutually converting an IP packet and a digital baseband signal. A DSP (Digital Signal Processor) 162 is a processor that executes signal processing in the BB processing module 152. A memory 172 is used as a work area of the DSP 162. The BB processing module 152 includes, for example, functions of the layer 2, etc., of the DL signal receiver 51 and the UL signal transmitter 52 of FIG. 28; the RRC processor 53; and the UE context manager 54. Note that all of or a part of the RRC processor 53 and the UE context manager 54 may be included in the device control module 153.

The device control module 153 executes protocol processing of an IP layer, processing of various applications, and so forth. A processor 163 is the processor that executes a process to be executed by the device control module 153. A memory 173 is used as a work area of the processor 163. Furthermore, the processor 163 reads out data from and writes data in the USIM through the USIM slot 154.

<Base Station eNB>

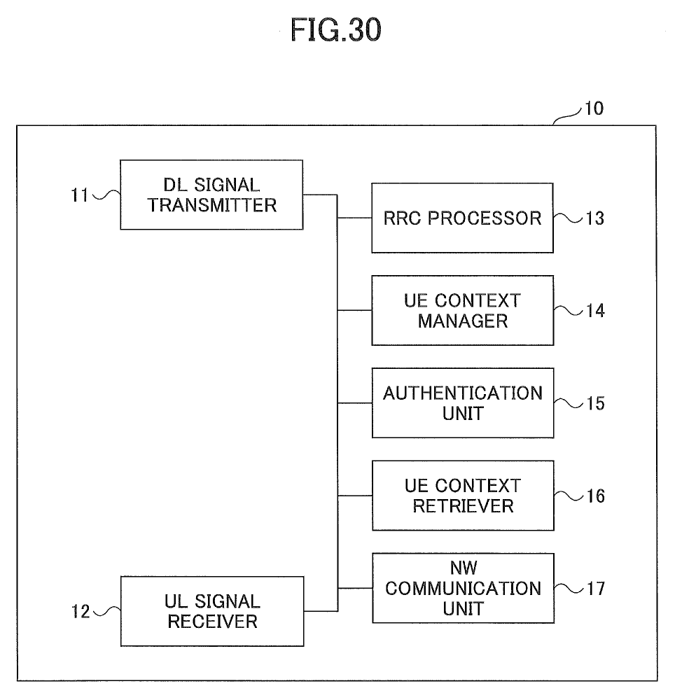

FIG. 30 is a functional configuration diagram of the base station eNB (eNB 10). As illustrated in FIG. 30, the eNB 10 includes a DL signal transmitter 11; a UL signal receiver 12; a RRC processor 13; a UE context manager 14; an authentication unit 15; a UE context retriever 16; and a NW communication unit 17. Note that, FIG. 30 only illustrates, in the eNB 10, the functional units that are particularly related to the present invention; and the eNB 10 includes, at least, functions, which are not depicted, for performing operations conforming to LTE.

The DL signal transmitter 11 includes a function for generating various types of physical layer signal from higher layer signals to be transmitted from the eNB 10, and for transmitting them. The UL signal receiver 12 includes a function for receiving various types of uplink signals from the user equipment UE and for retrieving higher layer information from the received physical layer signals.

The RRC processor 13 performs the determination process at the eNB side; generation and transmission of RRC messages (the transmission is through the DL signal transmitter 11); and parsing of RRC messages received through the UL signal receiver, etc., which are described by referring to FIG. 7 through FIG. 10, FIG. 12, FIG. 13, FIG. 15 through FIG. 26, etc. Furthermore, the RRC processor 13 includes, for example, the function for resuming the RRC connection using the UE context retained in the UE context manager 14.

The UE context manager 14 includes a storage unit, such as a memory; and retains the UE context and the UE identifier (e.g., S-TMSI) in the RRC suspension state/RRC idle state, for example, based on transmission of the command described in step 107, FIG. 13, etc. Furthermore, in the procedure illustrated in FIG. 12, based on the UE identifier received from the UE, the UE context is searched for; and, if it is confirmed that the UE context is retained, it indicates, to the RRC processor 13, to report that the UE context is retained and to request for authentication information.

The authentication unit 15 includes a function for receiving the authentication information from the UE and for performing authentication of the UE, at step 503 illustrated in FIG. 12.

If the UE context required for establishing the RRC connection with the UE (the RRC suspended state/RRC idle state) retaining the UE context is not stored in the UE context manager 14, the UE context retriever 16 executes the context retrieval procedure (e.g., FIG. 9, FIG. 10, FIG. 22, and FIG. 22), as described above. Furthermore, the UE context retriever 16 is provided with a function for, upon receiving a context request message from another base station, retrieving the UE context from the UE context manager 14 based on the information for identifying the target UE context, and returning it to the other base station.

The NW communication unit 17 includes a function for communicating control signals with the MME via the S1-MME interface; a function for communicating data with the S-GW via the S1-U interface; a function for transmitting a signal for indicating to maintain a connection; a transmission function for transmitting the RRC connection establishment complete, and so forth.

The entire configuration of the eNB 10 illustrated in FIG. 30 may be implemented by a hardware circuit (example: one or more IC chips); or a part of it may be configured by a hardware circuit, and the other part may be implemented by a CPU and a program.

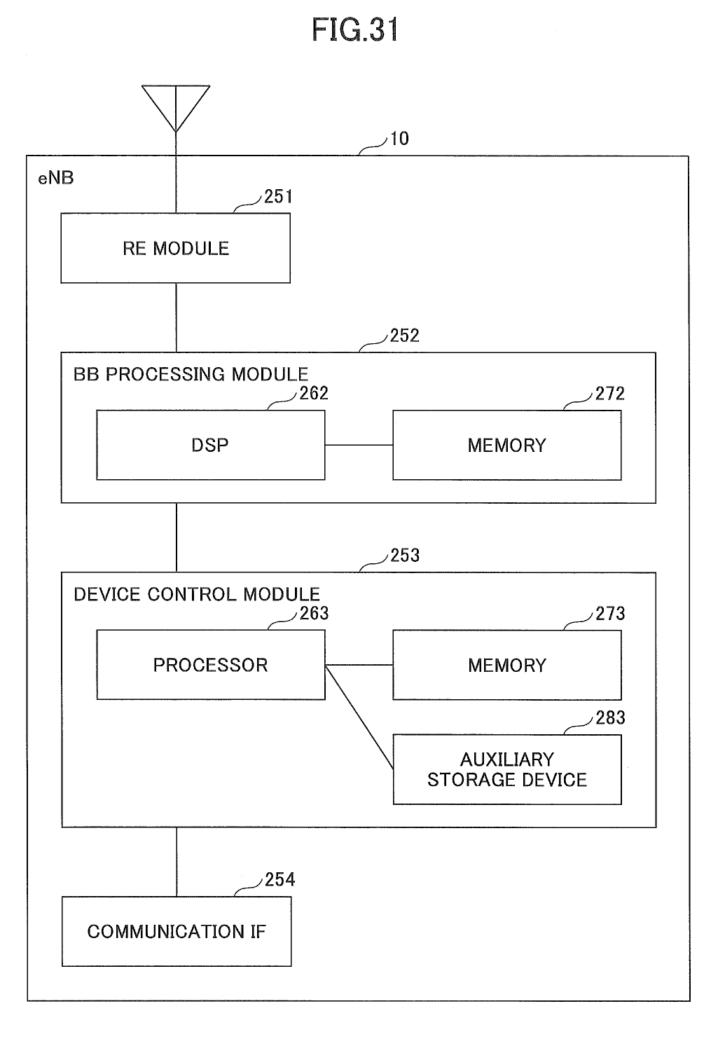

FIG. 31 is a diagram illustrating an example of a hardware configuration (HW) of the eNB 10. FIG. 31 illustrates a configuration that is closer to an implementation example, compared to FIG. 30. As illustrated in FIG. 31, the eNB 10 includes an RE module 251 that executes a process related to a radio signal; a BB processing module 252 that executes baseband signal processing; a device control module 253 that executes a process of, for example, a higher layer; and a communication IF 254 that is an interface for connecting to a network.

The RE module 251 generates a radio signal to be transmitted from an antenna by applying, for example, a D/A conversion; modulation; a frequency conversion; power amplification; and so forth to a digital baseband signal received from the BB processing module 252. Additionally, a digital baseband signal is generated by applying a frequency conversion, an A/D conversion, demodulation, and so forth to a received radio signal; and it is passed to the BB processing module 252. The RE module 251 includes, for example, functions of the physical layer, etc., in the DL signal transmitter 11 and the UL signal receiver 12 in FIG. 30.

The BB processing module 252 executes a process of mutually converting an IP packet and a digital baseband signal. A DSP 262 is a processor that executes signal processing in the BB processing module 252. A memory 272 is used as a work area of the DSP 252. The BB processing module 252 includes, for example, functions of the layer 2, etc., in the DL signal transmitter 11 and the UL signal receiver 12 in FIG. 30, the RRC processor 13, the UE context manager 14, the authentication unit 15, and the UE context retriever 16. Note that all of or a part of the functions of the RRC processor 13, the UE context manager 14, the authentication unit 15, and the UE context retriever 16 may be included in the device control module 253.

The device control module 253 executes protocol processing of an IP layer; OAM processing, and so forth. A processor 253 is the processor that executes a process to be executed by the device control module 253. A memory 273 is used as a work area of the processor 263. An auxiliary storage device 283 is, for example, a HDD; and stores various types of configuration information and so forth, which are for operating the base station eNB itself.

Note that the configuration (functional division) illustrated in FIG. 27 through FIG. 31 is an example of a configuration for implementing the processes described in the embodiment (which includes the embodiment 1 and the embodiment 2). The implementation method (installation of specific functional unit, names, etc.) is not limited to a specific implementation method, provided that the processes described in the embodiment (which includes the embodiment 1 and the embodiment 2) can be implemented.

### Conclusion of the Embodiment

As described above, according to the embodiment, there is provided user equipment of a mobile communication system supporting a function for establishing a connection by reusing context information retained in each of the user equipment and a base station, the user equipment including a transmitter that transmits, to the base station, first identifying information for identifying a retaining base station that retains base station side context information for the user equipment and second identifying information for identifying the base station side context information when the user equipment retains user equipment side context information; and a connector that establishes the connection with the base station by using the user equipment side context information after the base station obtains the base station side context information from the retaining base station.

With the above configuration, even if the user equipment that is not in a connected state moves between cells, the user equipment can establish a connection with the base station by reusing the context information, in the mobile communication system supporting the function for establishing the connection by reusing context information retained in each of the user equipment and the base station.

The user equipment may include a receiver that receives, from the base station, information indicating that the base station does not retain the base station side context information; and, upon receiving, by the receiver, the information indicating that the base station side context information is not retained, the transmitter may transmit the first identifying information and the second identifying information to the base station. With this configuration, the first identifying information and the second identifying information can be transmitted to the base station after confirming that the base station does not retain the base station side context information, so that unnecessary transmission of information can be avoided.

Furthermore, even if information indicating whether the base station retains the base station side context information is not received, the transmitter may transmit the first identifying information and the second identifying information to the base station. With this configuration, the user equipment can quickly transmit the first identifying information and the second identifying information to the base station without performing the process of confirming whether the base station retains the base station side context information.

Furthermore, according to the embodiment, there is provided a base station of a mobile communication system supporting a function for establishing a connection by reusing context information retained in each of user equipment and the base station, the base station including a receiver that receives, from the user equipment that retains user equipment side context information, first identifying information for identifying a retaining base station that retains base station side context information for the user equipment and second identifying information for identifying the base station side context information; and a context retriever that transmits, to the retaining base station identified by the first identifying information, a context request message including the second identifying information, and that obtains the base station side context information that is transmitted from the retaining base station in response to the context request message.

With the above configuration, even if the user equipment that is not in a connected state moves between cells, the user equipment can establish a connection with the base station by reusing the context information, in the mobile communication system supporting the function for establishing the connection by reusing context information retained in each of the user equipment and the base station.

The base station may include a transmitter that transmit, to the user equipment, information indicating that the base station does not retain the base station side context information, upon receiving, by the receiver, information indicating that the user equipment retains the user equipment side context information from the user equipment; and the receiver may receive the first identifying information and the second identifying information from the user equipment after transmitting, by the transmitter, information indicating that the base station side context information is not retained. With this configuration, the user equipment can transmit the first identifying information and the second identifying information to the base station if it can be confirmed that the base station does not retains the base station side context information, so that unnecessary transmission of information can be avoided.

Furthermore, even if the information indicating whether the base station retains the base station side context information is not received, the receiver may receive the first identifying information and the second identifying information from the user equipment. With this configuration, the base station can confirm whether the own device retains the base station side context information by using the second identifying information after receiving the first identifying information and the second identifying information.

When the base station side context information is not obtained, the context retriever may transmit a connection release message to the user equipment. With this configuration, the user equipment can be prompted to establish a connection by a normal method that does not reuse the context information.

The context retriever may obtain, upon receiving, from another base station, a context request message for user equipment under control of the other base station, base station side context information for the user equipment under control of the other base station from a storage unit, and may transmit the base station side context information to the other base station. With this configuration, in response to a request from another base station, the base station side context information can be provided to the other base station.

Note that, the “unit” in the configuration of each of the above-described devices may be replaced with “part,” “circuit,” “device,” and so forth.

The embodiment of the present invention is described above; however the disclosed invention is not limited to the embodiment, and a person ordinarily skilled in the art will appreciate various variations, modifications, alternatives, replacements, and so forth. Specific examples of numerical values are used in the description in order to facilitate understanding of the invention. However, these numerical values are merely an example, and any other appropriate values may be used, except as indicated otherwise. The separations of the items in the above description are not essential to the present invention. Depending on necessity, subject matter described in two or more items may be combined and used, and subject matter described in an item may be applied to subject matter described in another item (provided that they do not contradict). A boundary of a functional unit or a processor in the functional block diagrams may not necessarily correspond to a boundary of a physical component. An operation by a plurality of functional units may be physically executed by a single component, or an operation of a single functional unit may be physically executed by a plurality of components. For the convenience of description, each of the devices is described by using the functional block diagrams; however, such devices may be implemented in hardware, software, or combinations thereof. The software to be executed by the processor included in the device in accordance with the embodiment of the present invention may be stored in any appropriate storage medium, such as a random access memory (RAM), a flash memory, a read-only memory (ROM), an EPROM, an EEPROM, a register, a hard disk drive (HDD), a removable disk, a CD-ROM, a database, a server, and so forth.

### Additional Embodiments

Reporting of information is not limited to the aspects/embodiment described in this specification, and may be performed by another method. For example, reporting of information may be implemented by physical layer signaling (e.g., DCI (Downlink Control Information)), UCI (Uplink Control Information)), higher layer signaling (e.g., RRC signaling, MAC signaling, broadcast information (MIB (Master Information Block), SIB (System Information Block)), other signals or a combination thereof. Furthermore, the RRC message may be referred to as RRC signaling. Furthermore, the RRC message may be, for example, an RRC connection setup (RRC Connection Setup) message, an RRC connection reconfiguration (RRC Connection Reconfiguration) message, and so forth.

The aspects/embodiment described in the specification can be applied to LTE (Long Term Evolution); LTE-A (LTE-Advanced); SUPER 3G; IMT-Advanced; 4G; 5G; FRA (Future Radio Access); W-CDMA (registered trademark); GSM (registered trademark); CDMA 2000; UMB (Ultra Mobile Broadband); IEEE 802.11 (Wi-Fi); IEEE 802.16 (WiMAX); IEEE 802.20; UWB (Ultra-Wide Band); Bluetooth (registered trademark); a system that utilizes another suitable system and/or a next generation system evolved based on these.

The decision or determination may be performed by a value (0 or 1) represented by one bit; may be performed by a Boolean value (Boolean: true or false); or by numerical value comparison (e.g., a comparison with a predetermined value).

Note that the terms described in this specification and/or terms required for understanding the specification may be replaced with terms having the same or similar meanings. For example, a channel and/or a symbol may be a signal (signal). Furthermore, a signal may be a message.

The UE may be referred to, by a person skilled in the art, as a subscriber station; a mobile unit; a subscriber unit; a wireless unit; a remote unit; a mobile device; a wireless device; a wireless communication device; a remote device; a mobile subscriber station; an access terminal; a mobile terminal; a wireless terminal; a remote terminal; a handset; a user agent; a mobile client; a client; or some other suitable terms.

The each aspect/embodiment described in the specification may be used alone; may be used in combination; or may be used by switching depending on execution. Furthermore, reporting of predetermined information (e.g., reporting of “being X”) is not limited to explicit reporting, but also it may be implicitly performed (e.g., not performing reporting of the predetermined information).

The terms “determine (determining)” and “decide (determining)” may encompass a wide variety of operations. The “determine” and “decide” may include, for example, “determine” and “decide” what is calculated (calculating), computed (computing), processed (processing), derived (deriving), investigated (investigating), looked up (looking up) (e.g., looked up in tables, databases, or other data structures), ascertained (ascertaining). Furthermore, the “determine” and “decide” may include deeming that “determination” and “decision” are made on reception (receiving) (e.g., receiving information), transmission (transmitting) (e.g., transmitting information), input (input), output (output), and access (accessing) (e.g., accessing data in a memory). Furthermore, the “determine” and “decide” may include deeming that “determination” and “decision” are made on what is resolved (resolving), selected (selecting), chosen (choosing), established (establishing), and compared (comparing). Namely, the “determine” and “decide” may include deeming that some operation is “determined” or “decided.”

The phrase “based on” used in this specification does not imply “based only on” unless explicitly stated otherwise. In other words, the phrase “based on” implies both “based only on” and “based at least on.”

The order of the processing procedures, sequences, and so forth of the aspects/embodiment described in the specification may be re-arranged, provided that they do not contradict. For example, for the methods described in the specification, the elements of various steps are presented in an exemplary order, and are not limited to the specific order presented.

The input/output information, etc., may be stored in a specific location (e.g., a memory), or may be managed by a management table. The input/output information, etc., may be overwritten, updated, or added. The output information, etc., may be deleted. The input information, etc. may be transmitted to another device.

Reporting of predetermined information (e.g., reporting of “being X”) is not limited to explicit reporting, but also it may be implicitly performed (e.g., not performing reporting of the predetermined information).

The information, signals, etc., described in the specification may be represented by using any of various different techniques. For example, the data, instruction, command, information, signal, bit, symbol, chip, etc., which may be referred to over the entire description above, may be represented by a voltage, an electric current, an electromagnetic wave, a magnetic field or magnetic particles, a light field or photons, or any combination thereof.

The present invention is not limited to the above-described embodiment; and various variations, modifications, alternatives, replacements, and so forth are included in the present invention without departing from the spirit of the present invention.

This patent application is based upon and claims the benefit of priority of Japanese Patent Application No. 2015-218016 filed on Nov. 5, 2015 and Japanese Patent Application No. 2016-020322 filed on Feb. 4, 2016; and the entire contents of Japanese Patent Application No. 2015-218016 and Japanese Patent Application No. 2016-020322 are incorporated herein by reference.

### LIST OF REFERENCE SYMBOLS

10, 20: eNB
11: DL signal transmitter
12: UL signal receiver
13: RRC processor
14: UE context manager
15: authentication unit
16: UE context retreiver
17: NW communication unit
30: MME
31: eNB communication unit
32: SGW communication unit
33: communication controller
40: S-GW
41: eNB communication unit
42: MME communication unit
43: NW communication unit
44: communication controller
50: UE
51: DL signal receiver
52: UL signal transmitter
53: RRC processor
54: UE context manager
151: RE module
152: BB processing module
153: device control module
154: USIM slot
251: RE module
252: BB processing module
253: device control module
254: communication IF

1. User equipment of a mobile communication system supporting a function for establishing a connection by reusing context information retained in each of the user equipment and a base station, the user equipment comprising:
a transmitter that transmits, to the base station, first identifying information for identifying a retaining base station that retains base station side context information for the user equipment and second identifying information for identifying the base station side context information when the user equipment retains user equipment side context information; and
a connector that establishes the connection with the base station by using the user equipment side context information after the base station obtains the base station side context information from the retaining base station.

2. The user equipment according to claim 1, further comprising:
a receiver that receives, from the base station, information indicating that the base station does not retain the base station side context information,
wherein, upon receiving, by the receiver, the information indicating that the base station side context information is not retained, the transmitter transmits the first identifying information and the second identifying information to the base station.

3. The user equipment according to claim 1, wherein, even if information indicating whether the base station retains the base station side context information is not received, the transmitter transmits the first identifying information and the second identifying information to the base station.

4. A base station of a mobile communication system supporting a function for establishing a connection by reusing context information retained in each of user equipment and the base station, the base station comprising:
a receiver that receives, from the user equipment that retains user equipment side context information, first identifying information for identifying a retaining base station that retains base station side context information for the user equipment and second identifying information for identifying the base station side context information; and
a context retriever that transmits, to the retaining base station identified by the first identifying information, a context request message including the second identifying information, and that obtains the base station side context information that is transmitted from the retaining base station in response to the context request message.

5. The base station according to claim 4, further comprising:
a transmitter that transmits, to the user equipment, information indicating that the base station does not retain the base station side context information, upon receiving, by the receiver, information indicating that the user equipment retains the user equipment side context information from the user equipment,
wherein the receiver receives the first identifying information and the second identifying information from the user equipment after transmitting, by the transmitter, information indicating that the base station side context information is not retained.

6. The base station according to claim 4, wherein, even if information indicating whether the base station retains the base station side context information is not received, the receiver receives the first identifying information and the second identifying information from the user equipment.

7. The base station according to claim 4, wherein, when the base station side context information is not obtained, the context retriever transmits a connection release message to the user equipment.

8. The base station according to claim 4, wherein, upon receiving, from another base station, a context request message for user equipment under control of the other base station, the context retriever obtains base station side context information for the user equipment under control of the other base station from a storage unit, and transmits the base station side context information to the other base station.

9. A connection establishment method to be executed by user equipment of a mobile communication system supporting a function for establishing a connection by reusing context information retained in each of the user equipment and a base station, the connection establishment method comprising:
a transmission step of transmitting, to the base station, first identifying information for identifying a retaining base station that retains base station side context information for the user equipment and second identifying information for identifying the base station side context information when the user equipment retains user equipment side context information; and
a connection step of establishing the connection with the base station by using the user equipment side context information after the base station obtains the base station side context information from the retaining base station.

10. A content information retrieval method to be executed by a base station of a mobile communication system supporting a function for establishing a connection by reusing context information retained by each of user equipment and the base station, the content information retrieval method comprising:
a reception step of receiving, from the user equipment that retains user equipment side context information, first identifying information for identifying a retaining base station that retains base station side context information for the user equipment and second identifying information for identifying the base station side context information; and
a context retrieval step of transmitting, to the retaining base station identified by the first identifying information, a context request message including the second identifying information, and obtaining the base station side context information that is transmitted from the retaining base station in response to the context request message.
